(19) United States
(12) Patent Application Publication
(10) Pub. No.: US 2026/0086022 A1
(43) Pub. Date: Mar. 26, 2026

(54) AUTOREFERENCED AND SELF-ADJUSTED SPECTRAL SENSOR

(71) Applicant: Si-Ware Systems, Cairo (EG)

(72) Inventors: Yasser M. Sabry, Cairo (EG); Mohamed Ahmed Gaber, Cairo (EG); Bassem Mortada, Cairo (EG); Mohamed Hamouda, Cairo (EG); Ahmed Shebl, Cairo (EG); Mina Gad Seif, Cairo (EG); Sara Mahmoud, Cairo (EG); Ali Ghazala, Cairo (EG); Asmaa Mosbeh, Cairo (EG); Erik R. Deutsch, Brookline, MA (US); Mazen Erfan, Cairo (EG); Shady Labib, Cairo (EG)

(21) Appl. No.: 19/335,649

(22) Filed: Sep. 22, 2025

Related U.S. Application Data
(60) Provisional application No. 63/697,830, filed on Sep. 23, 2024.

(51) Int. Cl. G01N 21/27; G01N 21/25

(52) U.S. Cl. CPC G01N 21/274; G01N 21/255

(57) ABSTRACT

Aspects relate to a self-calibrated and self-referenced spectral sensor. The spectral sensor includes an optical head that includes a light source configured to produce input light, an optical window above the light source and through which the input light is directed towards a sample in a sample measurement mode, and a reflection flag (for self-calibration and self-referencing) that is moveable between a first position beneath the optical window within a light path of the input light in a reference measurement mode and a second position away from the light path in the sample measurement mode. The spectral sensor further includes an optical core module and a processor configured to produce a reference PSD in the reference measurement mode and a sample PSD in the sample measurement mode. The processor is further configured to correct the sample PSD based on the reference PSD to produce a sample spectrum.

### PRIORITY CLAIM

This application claims priority to and the benefit of Provisional Application No. 63/697,830, filed in the U.S. Patent and Trademark Office on Sep. 23, 2024, the entire content of which is incorporated herein by reference as if fully set forth below in its entirety and for all applicable purposes.

### TECHNICAL FIELD

The technology discussed below relates generally to optical spectral sensors, and in particular to a self-calibrated and self-referenced spectral sensor.

### BACKGROUND

A spectrometer measures a single-beam spectrum (e.g., a power spectral density (PSD)). The intensity of the single-beam spectrum is proportional to the power of the radiation reaching the detector. Diffuse reflectance spectroscopy may be utilized to study the molecular structure of a given material based on its spectral response. In diffuse reflectance spectroscopy, a light source (e.g., a wide band light source) directs incident light to the material. The incident light interacts with the material such that part of the light is transmitted, another part of the light is reflected, and another part of the light is scattered. The scattered portion is affected by the sample absorption spectrum and can be used to identify the material based on its spectral print. Diffuse reflectance spectroscopy can be used with different forms of the material, such as solids, powders, and liquids.

Inline spectroscopy enables real-time monitoring of production lines samples to obtain accurate and fast predictions. A wide range of industrial applications utilize an inline process, in which the spectrometer is integrated to the production line and the measurements are taken in real-time throughout the manufacturing process. This is unlike off-line methods that require sample preparation in isolation to the running process, leading to inaccurate results in addition to being time consuming. Industrial applications of inline spectroscopy include on-farm analysis of milk, grains and animal feed to determine different contents such as moisture, dry matter, fat, protein and pH-value. Moreover, these spectrometers can be used for quality control and monitoring in the food industry to determine the validity of the products. Other process controlling applications include pharmaceuticals, chemical manufacturing such as polymers and petrochemicals.

Various sensor features are needed to utilize the sensor in an autonomous and smart way in inline applications. For example, operator intervention may not be efficient most of the time to identify when a sensor part needs to be replaced. In this case, the replacement should be performed in a quick and easy way. In addition, there may be vibrations and other sensor dynamics affecting the sensor operation, which should be able to be self-corrected without operator intervention.

### SUMMARY

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In an example, a spectral sensor is provided that includes an optical head and a core sensor module. The optical head includes a light source configured to produce input light, an optical window directly above the light source and through which the input light is directed towards a sample and first diffuse reflected light is received from the sample in a sample measurement mode, a moveable reference flag moveable between a first position beneath the optical window and within a light path of the input light in a reference measurement mode and a second position away from the light path of the input light in the sample measurement mode, where the moveable reference flag is coupled to receive the input light and diffuse reflect the input light to produce second diffuse reflected light in the reference measurement mode, and an actuator configured to move the moveable reference flag between the first position and the second position. The core sensor module includes an optical core module configured to receive the first diffuse reflected light from the sample in the sample measurement mode and the second diffuse reflected light from the moveable reference flag in the reference measurement mode. The optical core module includes a light modulator configured to produce first modulated light based on the first diffuse reflected light and second modulated light based on the second diffuse reflected light, and a detector configured to produce a first output signal based on the first modulated light and a second output signal based on the second modulated light. The core sensor module further includes a processor configured to obtain a sample power spectral density (PSD) based on the first output signal and a reference PSD based on the second output signal. The processor is further configured to correct the sample PSD in both intensity and wavelength based on at least the reference PSD to produce a sample spectrum.

These and other aspects of the disclosure will become more fully understood upon a review of the detailed description, which follows. Other aspects, features, and examples of the present disclosure will become apparent to those of ordinary skill in the art, upon reviewing the following description of specific, exemplary aspects of the present disclosure in conjunction with the accompanying figures. While features of the present disclosure may be discussed relative to certain examples and figures below, all examples of the present disclosure can include one or more of the features discussed herein. In other words, while one or more examples may be discussed as having certain features, one or more of such features may also be used in accordance with the various examples of the disclosure discussed herein. In similar fashion, while exemplary aspects may be discussed below as device, system, or method aspects, it should be understood that such exemplary aspects can be implemented in various devices, systems, and methods.

### BRIEF DESCRIPTION OF THE DRAWINGS

FIG. 1 is a diagram illustrating a spectrometer according to some aspects.

FIG. 2 illustrates an example of a spectral sensor according to some aspects.

FIG. 3 is a diagram illustrating another example of a spectral sensor according to some aspects.

FIGS. 4A-4E illustrate an example of an optical head configured as a separate unit according to some aspects.

FIGS. 5A-5D illustrate an example of a core sensor module configured as a separate unit according to some aspects.

FIGS. 6A-6B are diagrams illustrating an example assembly of a spectral sensor according to some aspects.

FIG. 7 is a diagram illustrating a side view of the core sensor module according to some aspects.

FIGS. 8A and 8B are diagrams illustrating an example of a light source of the spectral sensor according to some aspects.

FIGS. 9A and 9B are diagrams illustrating an example of an optical head according to some aspects.

FIG. 10 is a diagram illustrating an example of illumination and collection components of the optical head according to some aspects.

FIGS. 11A-11C illustrate an example of a simulated ray tracing of the source and corresponding illumination spots at the sample and the moveable reference flag according to some aspects.

FIGS. 12A and 12B are diagrams illustrating an example of controlling the vertical position of a built-in moveable reference flag according to some aspects.

FIG. 13 is a diagram illustrating another example of controlling the vertical position of a built-in moveable reference flag according to some aspects.

FIG. 14 is a diagram illustrating an example of correcting a reference PSD based on a sensed parameter of a vertical position of the built-in moveable reference flag according to some aspects.

FIG. 15 is a diagram illustrating an algorithm that updates parameters for temperature compensation based on whether a temperature difference exceeds a threshold according to some aspects.

FIG. 16 is a diagram illustrating an example of integrated temperature sensors according to some aspects.

FIGS. 17A-17C are diagrams illustrating an example of dissipating heat from thermal aggressors according to some aspects.

FIG. 18 is a diagram illustrating an example of thermal stabilization of an optical core module (OCM) according to some aspects.

FIGS. 19A and 19B illustrate an example of wavelength detector cut-off points according to some aspects.

FIG. 20 is a diagram illustrating an example of a spectral sensor including an inertial sensor according to some aspects.

FIG. 21 is a diagram illustrating an example of correcting misalignments caused by a perturbation source according to some aspects.

FIG. 22 is a diagram illustrating an example of a spectral sensor including a moveable wavelength calibration flag according to some aspects.

FIG. 23 is a diagram illustrating an example of built-in flags according to some aspects.

FIGS. 24A and 24B are diagrams illustrating another example of a spectral sensor including a moveable wavelength calibration flag according to some aspects.

FIG. 25 is a diagram illustrating another example of a spectral sensor including a moveable wavelength calibration flag according to some aspects.

FIG. 26 is a diagram illustrating an example flow of various calibrations performed from the factory to the inline operation at the customer side according to some aspects.

FIG. 27 is a diagram illustrating an example of wavelength self-calibration according to some aspects.

FIG. 28 is a diagram illustrating an example of criteria for optical head replacement according to some aspects.

FIG. 29 is a diagram illustrating an example of a performance monitoring kit (PMK) that may be used to calibrate a self-referencing spectral sensor according to some aspects.

FIG. 30 is a diagram illustrating an example of spectral system monitoring process according to some aspects.

FIG. 31 is a diagram illustrating exemplary calibration and correction processes that can be applied to the spectral sensor according to some aspects.

FIGS. 32 and 33 are diagrams illustrating examples of system operation of a spectral sensor according to some aspects.

FIG. 34 is a diagram illustrating an example of an integrated spectral sensor according to some aspects.

FIG. 35 is a diagram illustrating cross-sectional and expanded views of various components of an integrated spectral sensor according to some aspects.

FIG. 36 is a diagram illustrating various thermal elements of a spectral sensor according to some aspects.

FIGS. 37A and 37B are diagrams illustrating various leakage paths and sealing mechanisms of a spectral sensor according to some aspects.

FIGS. 38A-38D are diagrams illustrating examples of external components that may be attached to a spectral sensor, according to some aspects.

FIGS. 39A and 39B are diagrams illustrating configurations of a power source of a spectral sensor according to some aspects.

FIGS. 40A and 40B are diagrams illustrating other examples of external components that may be attached to a spectral sensor, according to some aspects.

FIGS. 41A-41C are diagrams illustrating an example of an accessory that may be used with a spectral sensor according to some aspects.

FIGS. 42A and 42B are diagrams illustrating other examples of accessories that may be used with a spectral sensor according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

One possible drawback of spectral sensors is the drift of the sensor behavior due to environmental conditions, such as temperature and humidity changes that affect spectral system components response. Another possible source of the drift is the changes of the mechanical alignment of the system components, especially after a long period of operation. In traditional sensor systems, manual recalibration of the system can be performed as a maintenance process. However, inline systems require automated techniques to calibrate and correct the deviations of the spectral response due to the continuous operation and harsh conditions. This in turn requires multiple automated calibration cycles in a timely manner. Moreover, in inline spectral sensors, system monitoring may be required to detect whether a calibration process is needed or not. In addition, system monitoring greatly helps to determine whether the system components need to be replaced or if they are still in acceptable operational conditions. Well-controlled and monitored system specifications within acceptable criteria are needed to reduce any spectral variations between different sensors or variations of the same sensor response across long operational time.

Various aspects of the disclosure relate to a low-cost, self-calibrated, and self-referenced spectral sensor that can be used in various inline spectral applications. The spectral sensor includes an optical head and a core sensor module. The optical head includes a light source configured to produce input light, an optical window above the light source and through which the input light is directed towards a sample in a sample measurement mode. The optical head further includes a moveable reflection flag (for self-calibration and self-referencing) that is moveable between a first position beneath the optical window within a light path of the input light in a reference measurement mode and a second position away from the light path in the sample measurement mode. In addition, the optical head includes an actuator configured to move the moveable reflection flag between the first and second positions. The core sensor module includes an optical core module and a processor. The optical core module is beneath the optical head and includes a light modulator and a detector. The light modulator is configured to receive diffuse reflected light from the sample in the sample measurement mode and diffuse reflected light from the moveable reflection flag in the reference measurement mode and to produce modulated light based on the received diffuse reflected light. The detector is configured to produce an output signal based on the modulated light and to provide the output signal to the processor. The processor is configured to produce a reference power spectral density (PSD) from the output signal in the reference measurement mode and a sample PSD in the sample measurement mode. In addition, the processor is further configured to correct the sample PSD in both intensity and wavelength based at least on the reference PSD to produce a sample spectrum.

In some examples, the optical head and core sensor module are integrated into a single housing including the optical window on a top surface thereof and at least one fixation flange configured to attach the spectral sensor to one or more walls of the housing. In some examples, the housing further includes at least one heatsink attached to the one or more walls at the fixation flange(s), and an additional backside heatsink near a bottom surface of the housing.

In other examples, the optical head and core sensor module are separate components configured to be removably attached to one another to facilitate replacement of at least one of the optical head or core sensor module. In some examples, the optical head includes an electrical connector configured to connect to a mating element on the core sensor module for electrical connection therebetween and a mechanical connector configured to provide a mechanical connection to the core sensor module. In addition, the optical head and core sensor module can further include alignment pins configured to facilitate attachment of the optical head to the core sensor module. The optical head can further include a first aperture (e.g., within the mechanical connector) configured to be aligned with a second aperture on the core sensor module to provide the diffuse reflected light from the optical head to the core sensor module. In some examples, the light source can further be removed and replaced individually from the optical head. For example, the light source can include a plurality of filament lamps soldered on a circular board that can be inserted into and removed from the optical head. The light source may further include one or more reflectors surrounding the filament lamps on the circular board.

In some examples, the actuator includes a solenoid configured to move the moveable reference flag between the first position and the second position. In some examples, the optical head further includes an additional solenoid configured to control a vertical distance between the moveable reference flag and a fixed reference plate, and a capacitive sensing circuit configured to sense a sensed capacitance between the fixed reference plate and the moveable reference flag based on the vertical distance. In some examples, the capacitive sensing circuit is configured to convert the sensed capacitance into a current and to provide the current to the additional solenoid to adjust the vertical distance. In some examples, the capacitive sensing circuit is configured to provide the sensed capacitance to the processor to generate a correction matrix to apply to the reference PSD to produce a corrected reference PSD that is used to correct the sample PSD. In some examples, the optical head further includes an optical proximity sensor positioned on an arm of the moveable reference flag and configured to measure a vertical distance between the moveable reference flag and a reference surface and to provide the vertical distance to the processor to generate a correction matrix to be applied to the reference PSD to produce a corrected reference PSD that is used to correct the sample PSD.

In some examples, the processor is configured to divide a sample power spectral density (PSD) associated with the sample PSD by a reference PSD associated with the reference PSD to produce the sample spectrum. In some examples, the processor is configured to compensate for a spectral response difference between the reference PSD and the sample PSD based on a compensation function indicative of an optical power difference between the first position of the moveable reference flag and a sample position of the sample above the optical window. In some examples, the processor is further configured to calculate a power thermal drift of the reference PSD based on a correction matrix across a wavenumber vector of the reference PSD that is associated with a current temperature of the spectral sensor. Here, the processor is further configured to correct the sample PSD based on the power thermal drift to produce the sample spectrum.

In some examples, the processor is configured to obtain the reference PSD in response to a difference between the current temperature and a previous temperature associated with a previous reference PSD being greater than a threshold. In some examples, the spectral sensor further includes a thermo-electric cooling (TEC) system configured to stabilize the current temperature around the previous temperature in response to the difference between the current and previous temperatures being less than the threshold. In some examples, the TEC may be used in conjunction with and before applying the correction matrix if the allowed temperature difference between the sample PSD and the background/reference PSD is relatively large, exceeding an allowed temperature threshold margin. In this example, the TEC system alone or the correction matrix alone may be not enough to thermally stabilize the spectral response accurately, and thus, the TEC system may be applied prior to the correction matrix. In some examples, the core sensor module includes a sensor board having the optical core module configured thereon. The sensor board can include copper configured to dissipate heat from a thermal aggressor or minimize heat transfer between the optical core module and the thermal aggressor.

In some examples, the processor is further configured to determine a wavelength thermal drift of the reference PSD based on the current temperature and to correct the sample PSD based on the wavelength thermal drift to produce the sample spectrum. In some examples, the current temperature may be measured by one or more temperature sensors. In some examples, the current temperature may be determined based on a current wavelength detector cut-off point of the reference PSD.

In some examples, the spectral sensor further includes a moveable wavelength calibration flag that may be included in the optical head or the core sensor module. In examples in which the moveable wavelength calibration flag is included in the optical head, the moveable reference flag and moveable wavelength calibration flags may be operated sequentially (at different times) to produce respective reference PSDs that may be used to correct the sample PSD for both power/intensity (y-axis) and wavelength (x-axis). For example, the moveable wavelength calibration flag may be operated in a wavelength calibration mode to obtain a wavelength correction measurement to correct the wavelength vector of the sample PSD. In examples in which the moveable wavelength calibration flag is included in the core sensor module, the moveable reference flag and moveable wavelength calibration flag may be operated simultaneously to obtain the wavelength correction measurement in a combined reference/wavelength calibration mode to correct the wavelength vector of the sample and reference PSD. In some examples, instead of including a moveable wavelength calibration flag, the light source can include a light emitting diode (LED) having a specific wavelength in an operating spectral range of the spectral sensor that can be turned on during the combined reference/wavelength calibration mode to enable both power/intensity (y-axis) and wavelength (x-axis) correction of the sample and reference PSDs.

In some examples, the spectral sensor can further include an inertial sensor (e.g., an accelerometer, gyroscope, and/or other inertial sensor) configured to sense an inertial force on the spectral sensor. In some examples, the processor is configured to correct the sample PSD based on the inertial force. In other examples, the inertial force may be used to adjust an angle of a platform on which the spectral sensor is located with respect to a horizontal axis thereof.

In some examples, the processor is further configured to provide a signal requesting replacement of the optical head in response to detecting a power reduction above a threshold based on the reference PSD. In some examples, the processor is configured to provide a signal requesting calibration of the spectral sensor in response to replacement of the optical head, in response to at least one parameter associated with the reference PSD exceeding a threshold, or based on a periodicity of calibration. In some examples, the signal may indicate that calibration is to be performed using a performance monitoring/management kit that includes at least one external accessory placed on top of the optical window. In some examples, the spectral sensor is configured to operate in a pipeline configuration to process a previous sample scan during a same time period as obtaining a new sample scan. This can be extended to process a previous reference scan during a new sample scan, thus minimizing the overhead time needed for self-referencing and self-calibration.

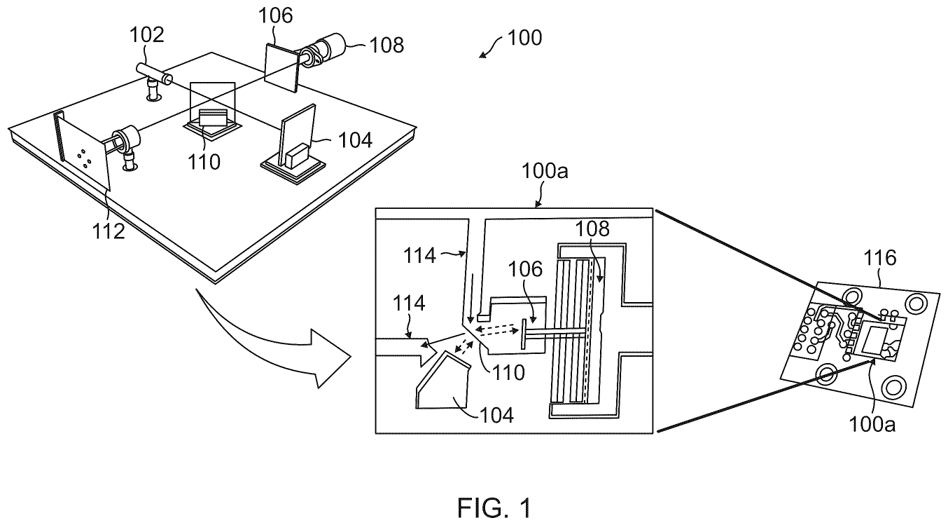

FIG. 1 is a diagram illustrating a spectrometer 100 according to some aspects. The spectrometer 100 may be, for example, a Fourier Transform infrared (FTIR) spectrometer. In the example shown in FIG. 1, the spectrometer 100 is a Michelson FTIR interferometer. In other examples, the spectrometer may include an FTIR Fabry-Perot interferometer.

FTIR spectrometers measure a single-beam spectrum (power spectral density (PSD)), where the intensity of the single-beam spectrum is proportional to the power of the radiation reaching the detector. In order to measure the spectrum of a sample, a background PSD (i.e., the single-beam spectrum in absence of a sample) may first be measured (e.g., prior to each sample measurement, periodically, or based on other factors) to compensate for any instrument transfer function(s). The single-beam spectrum of light transmitted, reflected, or trans-reflected from the sample under test (i.e., the sample PSD) may then be measured. The absorbance of the sample may be calculated from the transmittance, reflectance, or trans-reflectance of the sample. For example, the transmission, reflection, or trans-reflection spectrum of the sample may be calculated as the ratio of the PSD of the sample to the background PSD. The absorbance may then be obtained as, for example, −log 10 (sample spectrum).

The interferometer 100 includes a fixed mirror 104, a moveable mirror 106, a beam splitter 110, and a detector 112 (e.g., a photodetector). A light source 102 associated with the spectrometer 100 is configured to emit an input beam and to direct the input beam towards the beam splitter 110. The light source 102 may include, for example, a laser source, one or more wideband thermal radiation sources, or a quantum source with an array of light emitting devices that cover the wavelength range of interest.

The beam splitter 110 is configured to split the input beam into two beams. One beam is reflected off of the fixed mirror 104 back towards the beam splitter 110, while the other beam is reflected off of the moveable mirror 106 back towards the beam splitter 110. The moveable mirror 106 may be coupled to an actuator 108 to displace the movable mirror 106 to the desired position for reflection of the beam. An optical path length difference (OPD) is then created between the reflected beams that is substantially equal to twice the mirror 106 displacement. In some examples, the actuator 108 may include a micro-electro-mechanical systems (MEMS) actuator, a thermal actuator, or other type of actuator.

The reflected beams interfere at the beam splitter 110 to produce an output light beam, allowing the temporal coherence of the light to be measured at each different Optical Path Difference (OPD) offered by the moveable mirror 106. The signal corresponding to the output light beam may be detected and measured by the detector 112 at many discrete positions of the moveable mirror 106 to produce an interferogram. In some examples, the detector 112 may include a detector array or a single pixel detector. The interferogram data versus the OPD may then be input to a processor (not shown, for simplicity). The spectrum may then be retrieved, for example, using a Fourier transform carried out by the processor.

In some examples, the interferometer 100 may be implemented as a MEMS interferometer 100a (e.g., a MEMS chip). The MEMS chip 100a may then be attached to a printed circuit board (PCB) 116 that may include, for example, one or more processors, memory devices, buses, and/or other components. In some examples, the PCB 116 may include a spectral analyzer or other processor configured to receive and process the spectrum to produce spectral data. As used herein, the term MEMS refers to the integration of mechanical elements, sensors, actuators and electronics on a common silicon substrate through microfabrication technology. For example, the microelectronics are typically fabricated using an integrated circuit (IC) process, while the micromechanical components are fabricated using compatible micromachining processes that selectively etch away parts of the silicon wafer or add new structural layers to form the mechanical and electromechanical components. One example of a MEMS element is a micro-optical component having a dielectric or metallized surface working in a reflection or refraction mode. Other examples of MEMS elements include actuators, detector grooves and fiber grooves.

In the example shown in FIG. 1, the MEMS interferometer 100a may include the fixed mirror 104, moveable mirror 106, beam splitter 110, and MEMS actuator 108 for controlling the moveable mirror 106. In addition, the MEMS interferometer 100a may include fibers 114 for directing the input beam towards the beam splitter 110 and the output beam from the beam splitter 110 towards the detector (e.g., detector 112). In some examples, the MEMS interferometer 100a may be fabricated using a Deep Reactive Ion Etching (DRIE) process on a Silicon On Insulator (SOI) wafer in order to produce the micro-optical components and other MEMS elements that are able to process free-space optical beams propagating parallel to the SOI substrate. For example, the electro-mechanical designs may be printed on masks and the masks may be used to pattern the design over the silicon or SOI wafer by photolithography. The patterns may then be etched (e.g., by DRIE) using batch processes, and the resulting chips (e.g., MEMS chip 100a) may be diced and packaged (e.g., attached to the PCB 116).

For example, the beam splitter 110 may be a silicon/air interface beam splitter (e.g., a half-plane beam splitter) positioned at an angle (e.g., 45 degrees) from the input beam. The input beam may then be split into two beams L1 and L2, where L1 propagates in air towards the moveable mirror 106 and L2 propagates in silicon towards the fixed mirror 104. Here, L1 originates from the partial reflection of the input beam from the half-plane beam splitter 110, and thus has a reflection angle equal to the beam incidence angle. L2 originates from the partial transmission of the input beam through the half-plane beam splitter 110 and propagates in silicon at an angle determined by Snell's Law. In some examples, the fixed and moveable mirrors 104 and 106 are metallic mirrors, where selective metallization (e.g., using a shadow mask during a metallization step) is used to protect the beam splitter 110. In other examples, the mirrors 104 and 106 are vertical Bragg mirrors that can be realized using, for example, DRIE.

In some examples, the MEMS actuator 108 may be an electrostatic actuator formed of a comb drive and spring. For example, by applying a voltage to the comb drive, a potential difference results across the actuator 108, which induces a capacitance therein, causing a driving force to be generated as well as a restoring force from the spring, thereby causing a displacement of moveable mirror 106 to the desired position for reflection of the beam back towards the beam splitter 110.

The unique information from the vibrational absorption bands of a molecule is reflected in an infrared spectrum that may be produced, for example, by the spectrometer 100 shown in FIG. 1. By applying spectral numerical processing and statistical analysis to a spectrum, the information in the spectrum may be identified or otherwise classified. The application of statistical methods to the analysis of experimental data is traditionally known as chemometrics, and more recently as artificial intelligence.

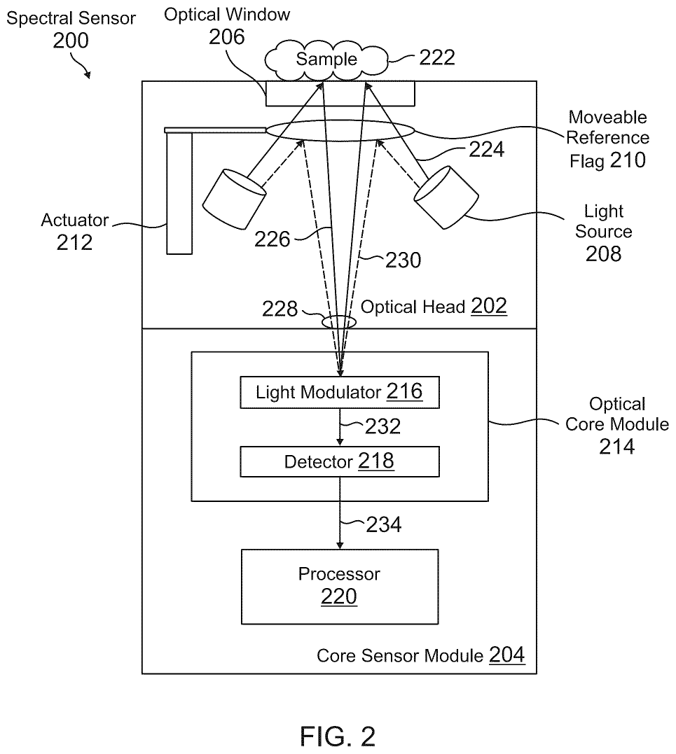

FIG. 2 illustrates an example of a spectral sensor according to some aspects. The spectral sensor 200 includes an optical head 202 and a core sensor module 204. The optical head 202 includes an optical window 206 on which a sample 222 may be placed. The optical head 202 further includes a light source 208 under the optical window 206. The light source 208 may include, for example, one or more filament bulbs (e.g., incandescent bulbs) or light emitting diodes (LEDs) configured to direct input light 224 (illumination light) through the optical window 206 towards the sample 222. The optical head 202 may further include illumination optics, such as one or more reflectors and/or lenses (not shown) configured to direct the input light 224 towards the optical window 206. The input light 224 may be diffusively reflected from the sample 222 as first diffuse reflected light 226 and directed through a collection aperture 228 to the core sensor module 204. In some examples, the optical head 202 may further include collection optics, such as reflectors and/or lenses (not shown) configured to focus and direct the first diffuse reflected light 226 on the collection aperture 228. In some examples, the collection aperture 228 may include a first aperture within the optical head 202 and a second aperture within the core sensor module 204.

The optical head 202 further includes a built-in moveable reference flag 210 that is moveable between a first position beneath the optical window 206 and within a light path of the input light 224 in a reference measurement mode and a second position beneath the optical window 206 and away from the light path of the input light 224 (e.g., non-overlapping to the optical window 206) in a sample measurement mode. In the reference measurement mode, the moveable reference flag 210 is in the first position to diffusely reflect the input light 224 as second diffuse reflected light 230 and direct the second diffuse reflected light 230 through the collection aperture 228 to the core sensor module 204. The flag diameter of the moveable reference flag 210 is large enough to cover the light spot in the reference measurement mode to obtain a reference/background measurement of the spectral sensor 200. The moveable reference flag 210 is inserted into and removed from the light path via an actuator 212. The actuator 212 may include, for example, a solenoid, stepper motor, or other suitable actuator. Thus, the actuator 212 is configured to move the moveable reference flag into the first position to obtain a reference/background measurement/PSD, and to move the moveable reference flag into the second position to obtain a sample measurement/PSD.

The core sensor module 204 includes an optical core module 214 and a processor 220. The processor 220 may include a single processing device or a plurality of processing devices. Such a processing device may be a microprocessor, micro-controller, digital signal processor, microcomputer, central processing unit, field programmable gate array, programmable logic device, logic circuitry, analog circuitry, digital circuitry, and/or any device that manipulates signals (analog and/or digital) based on hard coding of the circuitry and/or operational instructions.

The optical core module 214 includes a light modulator 216 configured to receive the first diffuse reflected light 226 from the optical head 202 in the sample measurement mode and the second diffuse reflected light 230 from the optical head 202 in the reference measurement mode. The light modulator 216 is configured to produce modulated light 232 from the diffuse reflected light 226/230. For example, the light modulator 216 may be configured to produce first modulated light 232 based on the first diffuse reflected light 226 in the sample measurement mode and to produce second modulated light 232 based on the second diffuse reflected light 230 in the reference measurement mode. The light modulator 216 may use a spectroscopic technique, including, but not limited to, direct absorption spectroscopy, indirect absorption spectroscopy, such as photo-acoustic spectroscopy, photo-thermal spectroscopy, or Raman spectroscopy. In some examples, the light modulator 216 may include a diffraction element, a Michelson interferometer, a Fabry-Perot cavity, a spatial light modulator, or a birefringent device. For example, the light modulator may include a MEMS interference device, such as the MEMS based interferometer, as shown in FIG. 1. The MEMS interferometer enables generating a spectrum in millisecond time scale since the moving micromirror is driven by a MEMS actuator. The optical core module 214 further includes a detector 218 (e.g., a photodetector or array of photodetectors) configured to produce an output signal 234 based on the modulated light 232. For example, the detector 218 may be configured to produce a first output signal 234 based on the first modulated light 232 and a second output signal 234 based on the second modulated light 232.

The processor 220 is configured to receive the output signal 234 (first output signal or second output signal) and obtain a power spectral density (PSD) based on the output signal 234. For example, the processor 220 may be configured to obtain a sample PSD based on the first output signal and a reference PSD based on the second output signal. The processor 220 can further be configured to correct the sample PSD in both intensity (power) and wavelength based on at least the reference PSD to produce a sample spectrum. In some examples, the processor 220 may be configured to enter the reference measurement mode to obtain the reference PSD based on a current temperature of the spectral sensor 200 (e.g., the current temperature exceeding a threshold) as measured by one or more temperature sensors (not shown) and/or extrapolated based on a current wavelength detector cut-off point of a reference PSD. In some examples, the processor 220 may be configured to enter the reference measurement mode upon replacement of one or more components (e.g., the optical head, core sensor module, light source, etc.) or based on a pre-configured periodicity of calibration of the spectral sensor 200 or each time the spectral sensor is switched on. In some examples, the processor 220 may be configured to enter the reference measurement mode before each sample measurement.

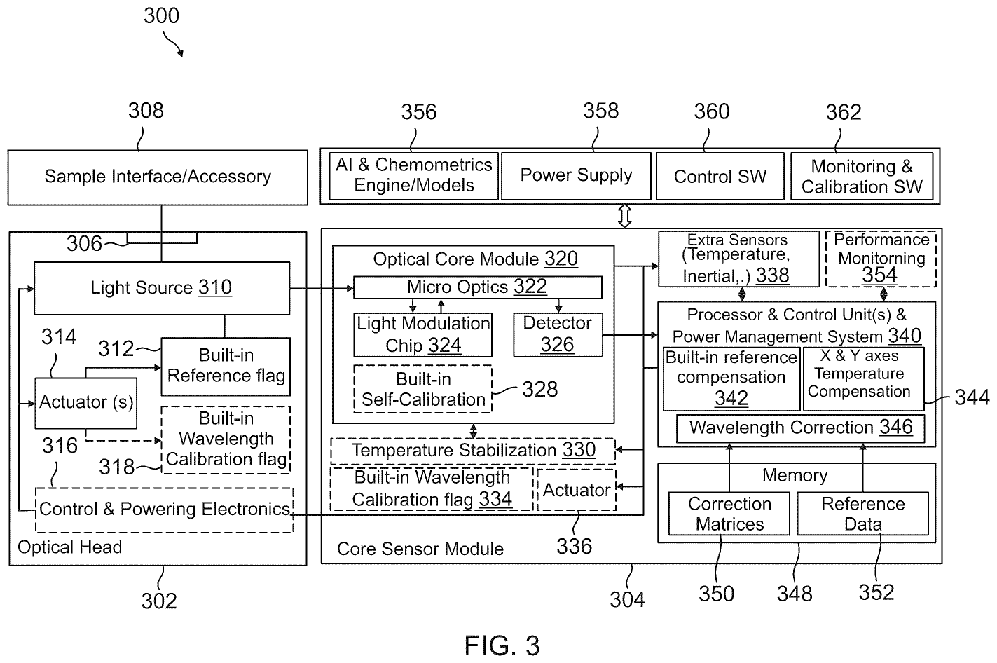

FIG. 3 is a diagram illustrating another example of a spectral sensor 300 according to some aspects. The spectral sensor 300 shown in FIG. 3 is a more detailed block diagram of various components, including one or more optional components of the spectral sensor 300. The spectral sensor 300 includes an optical head 302 and a core sensor module 304. The optical head 302 includes an optical window 306 on which a sample may be placed. In some examples, the spectral sensor 300 may further include a sample interface/accessory 308 that may be placed on the optical window 306. For example, the spectral sensor 300 may include a sample interface 308 configured to receive the sample and/or one or more accessories 308 and standard materials that may be placed on the optical window 306 (e.g., to calibrate the spectral sensor 300). In addition, the optical head 302 includes a light source 310 (e.g., one or more filament bulbs and/or LEDs) configured to direct input light towards the optical window 306.

The optical head 302 further includes a built-in moveable reference flag 312 that may be controlled by an actuator 314 to move the reference flag 312 into the light path of the input light to enable a reference measurement to be taken in a reference measurement mode and to move the reference flag away from the light path (out of the light path) of the input light to enable a sample measurement to be taken in a sample measurement mode. The optical head 302 may further include control and powering electronics 316 (e.g., an electrical control and driving board) to power and control the light source 310 and the actuator 314. In some examples, the optical head 302 may optionally further include a built-in moveable wavelength calibration flag 318 that may be moveable by the actuator 314 (or a separate actuator, not shown) into the light path of the input light to obtain a wavelength measurement in the wavelength calibration mode. For example, in the reference measurement mode, the actuator 314 may be configured to move the moveable reference flag 312 into the light path to obtain the reference (e.g., power intensity) measurement at a first time and then move the moveable reference flag 312 out of the light path of the input light and the moveable wavelength calibration flag 318 into the light path of the input light at a second time subsequent to the first time in the wavelength calibration mode to obtain the wavelength measurement. In some examples, the wavelength measurement may be taken at the first time and the reference measurement may be taken at the second time.

The core sensor module 304 includes an optical core module 320 that may include, for example, micro optics 322 (e.g., micro reflectors and/or lenses) configured to direct diffuse reflected light (e.g., from the sample in sample measurement mode or from the reference flag 312 in the reference measurement mode or wavelength calibration flag 318 in wavelength calibration mode) towards a light modulator 324 (e.g., a light modulation chip). In some examples, the micro optics 322 may be included in the optical head 302 (e.g., as illumination optics for directing/focusing the input light from the light source 310 towards the sample/flag and/or as collection optics for directing/focusing the diffuse reflected light towards the optical core module 320). For example, the micro optics 322 may be included in the optical head in addition to the optical core module 320 or in lieu of the optical core module 320 including any micro optics 322. As described above in connection with FIG. 2, the light modulator 324 is configured to modulate the diffuse reflected light to produce modulated light that is provided to a detector 326 (e.g., photodetector or array of photodetectors) to produce an output signal. The output signal may be input to a processor 340. The processor 340 may be configured to correct a sample PSD based on a reference PSD obtained using at least the built-in reference flag 312 in the optical head 302.

In some examples, the core sensor module 304 can further optically include a built-in wavelength calibration flag 334 that may be controlled by an actuator 336 (e.g., solenoid, stepper motor, etc.) within the core sensor module 304. In addition, the core sensor module 304 can further include a temperature stabilization system 330, such as a thermo-electric cooling (TEC) system configured to stabilize (or reduce) the temperature of the core sensor module, and in particular, the temperature of the optical core module 320 (including the light modulation chip 324 and detector 326). The core sensor module 304 can further include one or more additional sensors 338, such as one or more temperature sensors, one or more inertial sensors (e.g., accelerometers and/or gyroscopes), and other various types of sensors. In some examples, the processor 340 may further be configured to correct the sample PSD based on an inertial force sensed by an inertial sensor 338.

The processor 340 may be included, for example, on an electrical board that includes one or more control units (e.g., special electronic chips for system control) and that may further include a power management system to power different system components, including the optical head 302. In some examples, the core sensor module 304 may further include an internal battery or external battery coupled to the power management system (e.g., and powering and control circuitry on, for example, a power/control/communication board). In an example operation, the power management system can be configured to provide power to the various components of the spectral sensor 300, such as the optical core module 320 and the light source(s) 310. In addition, control circuitry (e.g., one or more control units) can control the light source(s) 310 to generate and direct the incident light to the sample. The control circuitry can further be configured to control the light modulator 324 and detector 326 to produce the interference beam and transmit the output signal to the processor 340. For example, the control circuitry may be configured to power on/off the light source 310 and optical core module 320 and to provide other control signals to, for example, the built-in reference flag 312 or wavelength-calibration flag 318/334. In addition, the control circuitry may be configured to control the processor 340 to perform a particular analysis/compensation/correction and/or to produce a particular result. The control circuitry may further be configured to control the flags 312/318/354, and processor 340 to switch between a sample measurement mode in which the sample PSD of the sample is obtained and a reference measurement mode in which a reference PSD of the built-in reference flag 312 (using a broadband light source without the sample or other flag) is obtained, and a wavelength calibration mode or combined reference/wavelength calibration mode in which a wavelength measurement is obtained using a wavelength calibration flag 318/334 to correct the wavelength vector (x-axis).

The processor 340 may include a single processing device or a plurality of processing devices. The processor 340 may further be coupled to a memory 348. The memory 348 may be a single memory device, a plurality of memory devices, and/or embedded circuitry of the processor 340. Such a memory device may be a read-only memory, random access memory, volatile memory, non-volatile memory, static memory, dynamic memory, flash memory, cache memory, and/or any device that stores digital information, including instructions (e.g., code) that may be executed by the processor 340.

In some examples, the processor 340 may include reference compensation circuitry 342 (e.g., which may execute reference compensation instructions that may be stored, for example, on the memory 348). The reference compensation circuitry 342 may be configured to obtain a reference PSD using the built-in reference flag 312 and to correct a sample PSD based on the reference PSD. In some examples, the processor 340 is configured to divide the reference PSD by the sample PSD to produce a sample spectrum. In some examples, the reference compensation circuitry 342 is further configured to compensate for a spectral response difference between the reference PSD and the sample PSD based on a compensation function indicative of an optical power difference between the position of the built-in reference flag 312 beneath the optical window 306 and the position of the sample above the optical window 306. In addition, the existence of the optical window 306 can introduce some spectral variations besides the difference in the vertical distance between the sample and the reference flag 312. The compensation function can further be utilized to eliminate flag-to-flag variations due to the flag fabrication, using, for example, golden reference standard(s) measured above the optical window 306. Added accessories 308 for the sampling interface may further introduce height differences between the sample location and the reference location. In addition, an accessory may further include an extra window, leading to an extra difference in spectral response that changes the position of the sample compared to the built-in reference flag 312, and therefore, the compensation function can further account for the added accessory 308 and any possible spectral variations introduced thereby.

In some examples, the processor 340 may include temperature compensation circuitry 344 (e.g., which may execute temperature compensation instructions that may be stored, for example, on the memory 348) that is configured to compensate for a thermal drift of the reference and sample PSDs. For example, the memory 348 may store one or more correction matrices 350, one of which may correspond to a power/intensity (e.g., y-axis) thermal drift associated with a current temperature of the spectral sensor 300. In this example, the current temperature may be obtained by a temperature sensor 338 or may be determined based on a current wavelength detector cut-off point of the reference PSD. The temperature compensation circuitry 344 may then calculate the power thermal drift of the reference PSD across a wavenumber vector of the reference PSD based on a correction matrix associated with the spectral sensor 300 and saved to the memory 348. The temperature compensation circuitry 344 may then correct the sample PSD based on the power thermal drift to produce the corrected sample spectrum.

The temperature compensation circuitry 344 may further be configured to compensate for a wavelength (e.g., x-axis) thermal drift associated with the current temperature of the spectral sensor 300. For example, the temperature compensation circuitry 344 may be configured to multiply the wavenumber vector of the reference PSD by at least one wavenumber correction factor determined based on one or more correction matrices 350 to calculate the wavelength thermal drift of the reference PSD. The temperature compensation circuitry 344 may then be configured to correct the sample PSD based on the wavelength thermal drift to produce the corrected sample spectrum.

In some examples, the memory 348 may further store reference data 352, such as a previous temperature and previous reference PSD obtained at the previous reference temperature. The processor 340 may be configured to obtain a new/current reference PSD and replace the previous reference PSD/previous temperature with the new/current reference PSD/current temperature in response to a difference between the current temperature and the previous temperature being greater than a threshold (e.g., which may be stored in the memory 348 as part of the reference data 352). In some examples, the processor 340 (e.g., a control unit) may be configured to instruct the TEC system 330 to apply temperature stabilization around the previous temperature in response to the difference between the current temperature and the previous temperature being less than the threshold. In this example, the new reference PSD may not be obtained.

In some examples, the processor 340 may further include wavelength correction circuitry 346 (e.g., which may execute wavelength correction instructions that may be stored, for example, on the memory 348). The wavelength correction circuitry 346 may be configured to correct the sample PSD and the reference PSD based on the wavelength measurement obtained using the wavelength calibration flag 318/334. For example, the reference data 352 stored in the memory 350 may include a plurality of standard wavelength peaks. The wavelength correction circuitry 346 may be configured to obtain a plurality of reference wavelength peaks based on the wavelength measurement and calculate a plurality of wavenumber correction factors based on the plurality of standard wavelength peaks and the plurality of reference wavelength peaks. The wavelength correction circuitry 346 may then be configured to correct the reference PSD and the sample PSD based on the plurality of wavenumber correction factors to produce the sample spectrum.

In some examples, the wavelength correction circuitry 346 may be configured to correct the wavelength vector of the sample and reference PSDs based on a wavelength correction measurement obtained in the combined reference/wavelength calibration mode by simultaneously operating the wavelength calibration flag 334 in the core sensor module 304 and the reference flag 312 in the optical head 302. The processor 340 can be configured to divide (e.g., after wavelength correction) the sample PSD by the reference PSD to obtain the corrected sample spectrum. In some examples, the light source 310 includes a reference light emitting diode (LED) having a specific wavelength that is turned on in the combined reference/wavelength calibration mode (while all other LEDs/lamps are turned off) in conjunction with operating the reference flag 312 in the optical head 302. In this example, the wavelength correction circuitry 346 may be configured to apply wavelength correction to the sample and reference PSDs and obtain the corrected sample spectrum based on a reference peak location of the reference LED in the wavelength measurement.

In other examples, instead of using a wavelength-calibration flag 334/318 or calibration LED in the light source 310, wavelength self-calibration may be performed by spectral sensors based on MEMS interferometer(s) in the light modulation chip 324 with a capacitive-sensing mirror position technique, where the known wavelength errors are mainly related to the drift of the electronic components used for capacitive sensing with ambient conditions, such as temperature and humidity variations. Using this technology, wavelength correction can be done with the built-in reference background flag 312 only in the reference measurement mode. To apply this correction, the information of reference optical points (bursts) in the interferogram shape of the built-in reference flag 312 associated with broadband light, including the main burst and at least one secondary burst, are utilized. The position of the main burst is at the zero OPD, while the second burst position is determined according to the design of the moving mirrors based on a built-in self-calibration circuit 328 in the optical core module 320 configured to recalibrate the relation between capacitive sensing and optical path difference (OPD) through a Capacitance to Mirror Displacement C2X relation stored as a reference data 352 in the memory 348. Here, the processor (e.g., processor 220/340) can be configured to apply wavelength correction to the wavelength vector of the sample and reference PSDs based on the C2X relation.

The core sensor module 304 may further optionally include performance monitoring circuitry 354 (e.g., which may be included on the electrical board containing the processor/control unit(s) 340). The performance monitoring circuitry 354 can be configured to generate a signal (e.g., to the processor 340) requesting calibration of the spectral sensor in response to replacement of one or more of the optical head 302, light source 310, and/or core sensor module 304, based on at least one parameter associated with the reference PSD exceeding a threshold (e.g., which can be stored as reference data 352 within the memory 348), or based on a periodicity of calibration (e.g., using a timer/timer threshold that may be stored in memory 348 and incremented by the performance monitoring circuitry). In some examples, the signal indicated to perform calibration using a performance monitoring/management kit (PMK) that includes at least one external standard material (e.g., an accessory 308) that may be placed on top of the optical window 306. In this example, the signal may be provided to an optional user interface or display (not shown) on the spectral sensor or to an external computing device or wireless device via, for example, a network interface or transceiver/antenna (not shown).

In some examples, the built-in reference flag 312 can be also used for light source 310 power level monitoring and aging thereof. For example, the power spectral density (PSD) level of the built-in reference flag can be monitored over time to detect when the lamps aging exceed allowed system margins (e.g., exceed a threshold). System maintenance may be needed in the case of alarming power reduction, which may require optical head replacement. Thus, in some examples, the performance monitoring circuitry 354 may be configured to provide a signal (e.g., to a user of the spectral system) requesting replacement of the optical head in response to detecting a power reduction above a threshold (e.g., which may be stored as reference data 352 in the memory 348) based on the reference PSD. In some examples, the signal may be provided to an external computing device or wireless device via, for example, a network interface or transceiver/antenna (not shown). In some examples, the signal may be provided to an optional user interface (not shown) on the spectral sensor 300.

The spectral sensor 300 may further optionally include an artificial intelligence (AI) chemometrics engine/models 356. In some examples, the AI engine 356 can include or may access one or more calibration models, each built for a respective type of analyte (sample) under test. The AI engine may fully reside in hardware and/or software on the spectral sensor 300 or may be implemented using a cloud-based AI engine. In this example, a local AI engine residing in hardware and/or software on the spectral sensor 300 may be in communication with (e.g., wireless communication) the cloud-based AI engine. For example, the cloud-based AI engine may provide access to one or more cloud-based calibration models that may be downloaded into the local AI engine. In some examples, the processor 340 may include circuitry configured to execute the AI engine 356 (e.g., software or instructions for performing AI engine functions). In other examples, the spectral sensor 300 may include dedicated AI circuitry (e.g., one or more application specific integrated circuits (ASICs)) configured to perform one or more functions of the AI engine 356. The spectral sensor 300 may further optionally include a power supply 358 (e.g., a battery), control software 360 (e.g., which may be stored on memory 348 and executed by the processor/control unit(s) 340), and/or monitoring and calibration software 362 (e.g., which may be stored on the memory 348 and executed by the processor 340 and/or performance monitoring circuitry 354).

The spectral sensor 300, therefore, has the capability of self-referencing and self-calibration using the built-in reference flag 312 and either the built-in wavelength calibration flag 318 or 334, the reference LED, or temperature compensation circuitry 344. This self-referencing and self-calibration can overcome the impact of changes in the sensor temperature and environment. It can also be used in self-testing of the sensor specifications (e.g., by the performance monitoring circuitry 354) every time the sensor 300 is switched on or periodically (e.g., daily/weekly/monthly/etc.). Flag 312 is used for self-referencing of the sample spectrum (intensity y-axis) and enables self-calibration of the wavelength vector (x-axis) of the measured reference and sample PSDs and consequently the sample spectrum, where flag 312 can contribute directly or indirectly. It directly enables the self-calibration feature inside the light modulation chip, reflecting light from the source to the light modulation chip. The reference flag enables calibration using the reference LED as well, where it reflects light of the LED to light modulation chip and the detector. It also directly enables self-calibration reflecting light to pass through the other transmission-based reference material/filter flags 318/334. The reference flag 312 enables wavelength self-calibration acting as a background calibration for the other reference material flags 313/334 or reference LED. Measuring the PSD of the second reference material flag or the LED only won't guarantee proper x-axis correction as it can be affected by device spectral drifts that have to be calibrated by a background measurement done by the main reflection-based flag 312 used for intensity calibration.

The spectral sensor 300 may be configured as an integrated unit with a single housing containing both the optical head 302 and the core sensor module 304 or as separate units/housings, each containing one of the optical head 302 or the core sensor module 304. In the latter example, the optical head 302 and core sensor module 304 may be removably attached to one another to facilitate replacement of one or more of the optical head 302 and the core sensor module 304.

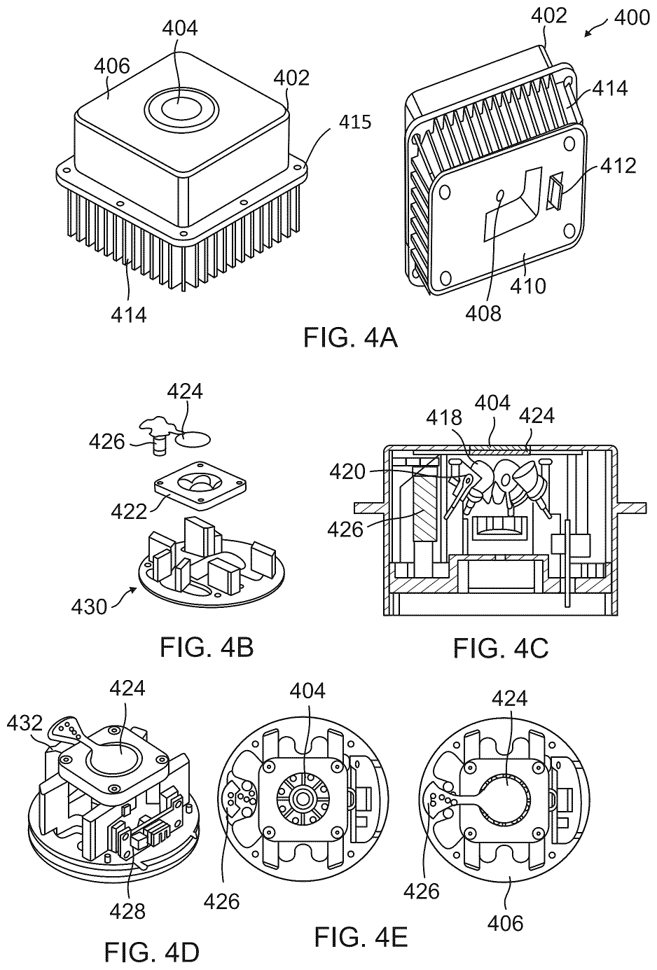

FIGS. 4A-4E illustrate an example of an optical head 400 configured as a separate unit (separate from the core sensor module) according to some aspects. FIG. 4A illustrates an optical head 400 that includes an optical head housing body 402 having a top surface 406, a bottom surface 410, and walls 414 within which components of the optical head 400 are contained. FIG. 4B illustrates an expanded view of various components of the optical head 400, FIG. 4C illustrates a cross-sectional view of the various components of the optical head 400, FIG. 4D illustrates an assembled view of the various components of the optical head 400, and FIG. 4E illustrates a bottom view (internal view) of the top surface 406 of the optical head housing body 402.

As shown in FIG. 4A, an optical window 404 is located on (e.g., contained within) the top surface 406 of the optical head housing body 402. In addition, an aperture 408 (e.g., a collection aperture through which diffuse reflected light is transmitted) and a power/control board electrical connector 412 are provided on the bottom surface 410 of the optical head housing body 402. The electrical connector 412 is configured to provide a power/electrical connection between the optical head 400 and a core sensor module (not shown). The optical head 400 further includes a fixation flange 415 (e.g. a lip or rim) around an outer/external surface of the walls 414 of the optical head housing body 402. In the example shown in FIG. 4A, the walls 414 have a rectangular prism or cubic shape; however, it should be understood that other shapes are contemplated in the scope of the application. The fixation flange 415 is configured to facilitate fixation of (e.g., attachment to) the optical head 400 to a core sensor module.

As shown in FIGS. 4B-4E, the components of the optical head 400 can include, for example, a light source 418, including for example, a plurality of filament lamps or LEDs. The light source 418 is configured to generate/emit input light, which may be directed/focused towards the optical window 404 via illumination optics 420 (e.g., one or more reflectors or lenses). In the example shown in FIG. 4C, the illumination optics 420 include reflectors positioned on a back side of a plurality of filament lamps to reflect stray light from the lamps towards the optical window 404. For example, the filament lamps 418 may be assembled into the reflectors 420 to redirect the input light to a sample on the optical window 404. The reflectors 420 and light source 418 may be held in place by a reflector holder 422. In some examples, the number of required lamps 418 may be calculated based on the required optical intensity to achieve a desired signal-to-noise ratio (SNR) of illumination on the sample, taking into account all of the losses and efficiencies of the lamps, such as the electrical-to-optical power efficiency. The geometric shape of the reflectors 420 can be in any form, such as parabolic or elliptical shape according to the required intensity. The filament lamps 418 are positioned at the focus achieving either light collimation or focusing on the sample. The position, orientation, and shift from the center of the reflector 420 and corresponding lamp 418 are also optimized to accomplish the required illumination spatial spot size, intensity and spot uniformity on the sample.

As further shown in FIGS. 4B-4E, the optical head 400 further includes a moveable reference flag 424 that is coupled to an actuator (e.g., solenoid) 426. The actuator 426 is configured to move the reference flag 424 between a first position beneath the optical window 404 and within a light path of the input light from the light source 418 and a second position that is beneath the reflector and away from (outside of) the light path of the input light. The reference flag 424 is located beneath (underneath) the optical window 404 to protect the reference flag 424. In some examples, the actuator (solenoid) 426 is attached to the light source head to move the reference flag 424. For example, the actuator 426 may be attached to a bracket holder 432 integrated with the reflector holder 422 of the optical head 400. The optical head 400 further includes a power/control board 428 configured to supply power to and control operation of the light source 418 and solenoid 426. A mechanical body/chassis 430 is configured to support each of the components of the optical head 400.

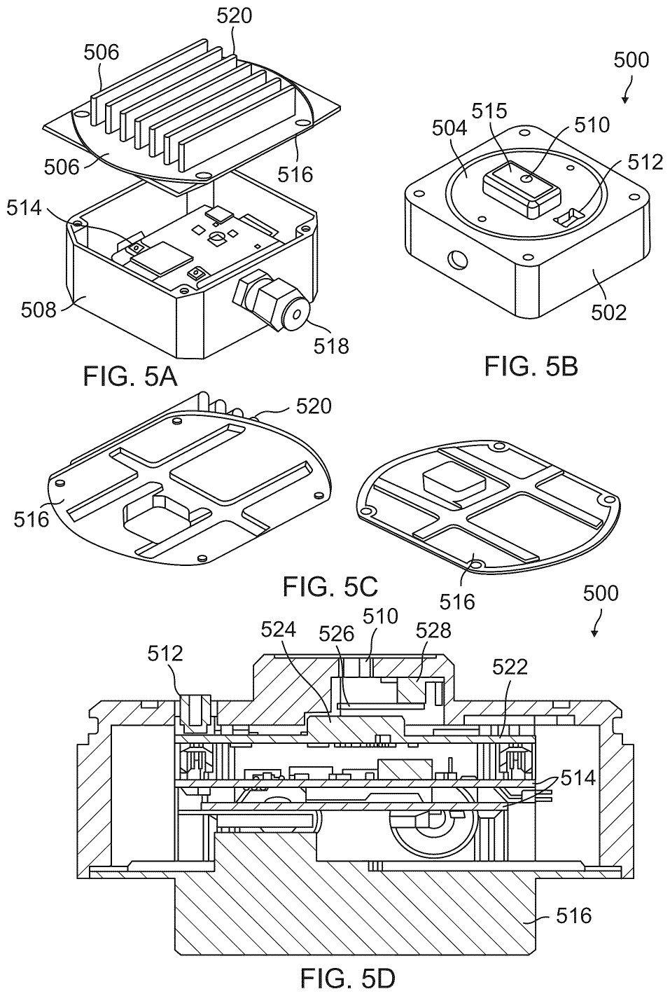

FIGS. 5A-5D illustrate an example of a core sensor module 500 configured as a separate unit (separate from the optical head) according to some aspects. FIGS. 5A and 5B illustrate a core sensor module 500 that includes a core sensor housing body 502 having a top surface 504, a bottom surface 506, and walls 508 (e.g., rectangular or cylindrical walls) within which components of the core sensor module 500 are contained. FIG. 5A illustrates an expanded view of various components of the core sensor module 500 as viewed from the bottom surface 506 of the core sensor module housing body 502. FIG. 5B illustrates various components on the top surface 504 of the core sensor module housing body 502. FIG. 5C illustrates a backside cover 516 of the core sensor module 500. FIG. 5D illustrates a cross-sectional view of the various components of the core sensor module 500.

As shown in FIGS. 5A, 5C and 5D, the components of the core sensor module 500 can include power, control, and communication boards 514 that may be coupled, for example, to external power and communication ports 518. The power, control, and communication boards 514 may include, for example, one or more processors, control units, and/or power management systems (e.g., processor 220 shown in FIG. 2 or processor/control unit/power management system 340 shown in FIG. 3). In addition, the bottom surface 506 may be formed of a backside cover 516 that includes an optional heatsink 520 on an external surface thereof. As shown in FIG. 5B, the top surface 504 of the core sensor housing body 502 an aperture 510 through which diffuse reflected light is transmitted from the optical head. In addition, the top surface 504 includes a mating element 512 configured to couple to the electrical connector (power/board connector) on the optical head (as shown in FIG. 4A). The top surface 504 may further include a mechanical connector 515 configured to facilitate attachment of the optical head to the core sensor module 500. In the example shown in FIG. 5A, the aperture 510 is included within the mechanical connector 515.

As shown in FIG. 5D, the core sensor module 500 can further include a core sensor board 522 on which an optical core module (OCM) chip 524 may be positioned. The OCM chip 524 can include, for example, a light modulator and a detector, as described above in connection with FIGS. 2 and 3. Diffuse reflected light from the optical head can enter the core sensor module 500 through the aperture 510 and may then be directed to the OCM chip 524 via, for example, micro optics (e.g., one or more reflectors, lenses, collimating optical elements, and/or other suitable optical component(s)). In some examples, the core sensor module 500 can further include an optional wavelength calibration flag 526 that may be controlled by an optional actuator (e.g., solenoid) 528. The actuator 528 may be configured to move the wavelength calibration flag 526 between a first position below the aperture 510 and above the OCM chip 524 (e.g., between the aperture 510 and the light modulator) and within a light path of the diffuse reflected light and a second position between the aperture 510 and light modulator (OCM chip 524) away from the light path of the diffuse reflected light.

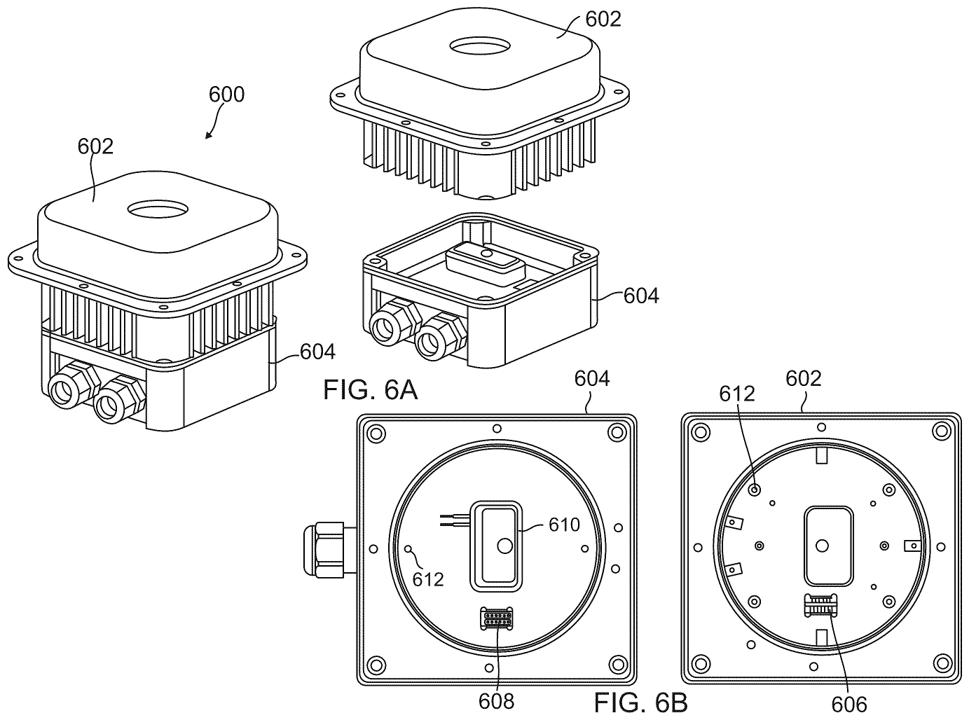

FIGS. 6A-6B are diagrams illustrating an example assembly of a spectral sensor 600 according to some aspects. As shown in FIG. 6A, the assembled spectral sensor 600 includes an optical head 602 removably attached to a separate core sensor module 604. As further shown in FIG. 6B, the optical head 602 includes an electrical connector 606 configured to connect to a mating element 608 on the core sensor module 604 to provide an electrical/power connection therebetween. A mechanical connector 610 on the core sensor module 604 is used to enable easy assembly and robust connection of the optical head 602 and core sensor module 604. In addition, to ensure that the assembly is performed in the correct direction and with the correct alignment between the optical head 602 and the core sensor module 604, alignment pins 612 on the optical head 602 and core sensor module 604 can be provided to ensure close tolerances. The optical head 602 and core sensor module 604 can further be detached from one another to enable replacement of one or both of the optical head 602 and the core sensor module 604. In some examples, as most of the degradation during continuous operation in an inline application occurs in the optical head light source (filament lamps/LEDs), replacement of the optical head 602 may occur more frequently than replacement of the core sensor module 604 to ensure a long lifetime of the spectral sensor 600. In some examples, only the optical head 602 may be replaced, so that a new optical head 602 may be utilized with the same (existing) core sensor module 604.

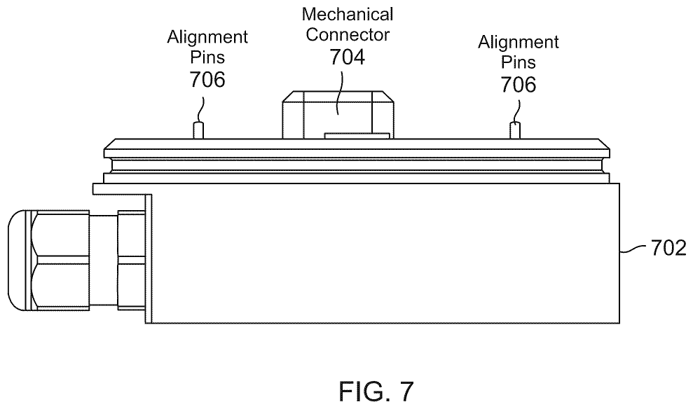

FIG. 7 is a diagram illustrating a side view of the core sensor module according to some aspects. The core sensor module 702 includes a mechanical connector 704 configured to facilitate attachment of the core sensor module 702 to an optical head. In addition, the core sensor module 702 includes alignment pins 706 configured to align the core sensor module 702 with the optical head to facilitate attachment of the core sensor module 702 to the optical head via the mechanical connector 704.

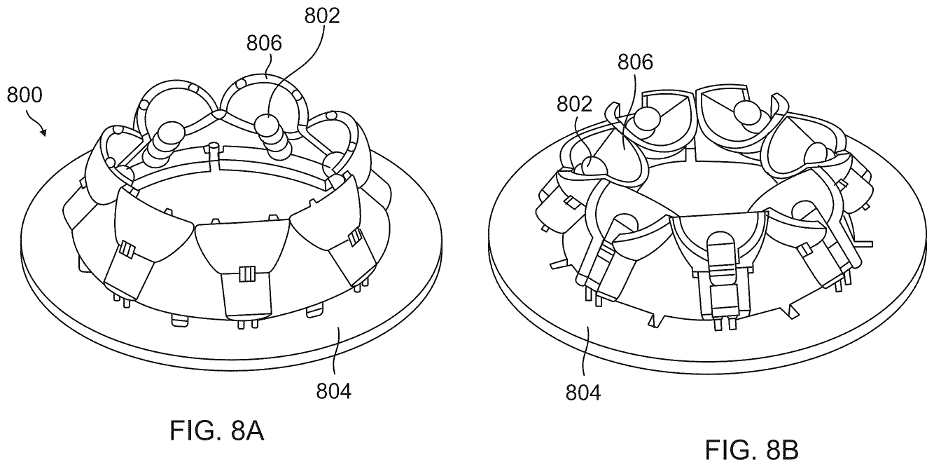

FIGS. 8A and 8B are diagrams illustrating an example of a light source of the spectral sensor according to some aspects. FIG. 8A illustrates a bottom view of the light source 800, whereas FIG. 8B illustrates a top view of the light source 800. The light source 800 can include a plurality of filament lamps/light bulbs 802 arranged in a circular configuration on an internal surface of a circular board 804. In addition, a plurality of reflectors 806 may further be attached to the circular board 804. For example, the filament lamps 802 may be soldered to the circular board 804 with the reflectors 806 also fixed to the board 804. In the example shown in FIGS. 8A and 8B, each filament lamp 802 is surrounded on one side thereof by a respective reflector 806. Each reflector 806 has a parabolic or elliptical shape and is positioned to reflect input light from the corresponding filament lamp 802 towards an optical window (sample/reference flag). In some examples, the entire light source unit 800, including the filament lamps 802, circular board 804, and reflectors 806 may be removably attached or secured to, for example, the reflector holder 422 shown in FIG. 4 to facilitate replacement of the light source unit 800 without requirement replacement of the entire optical head.

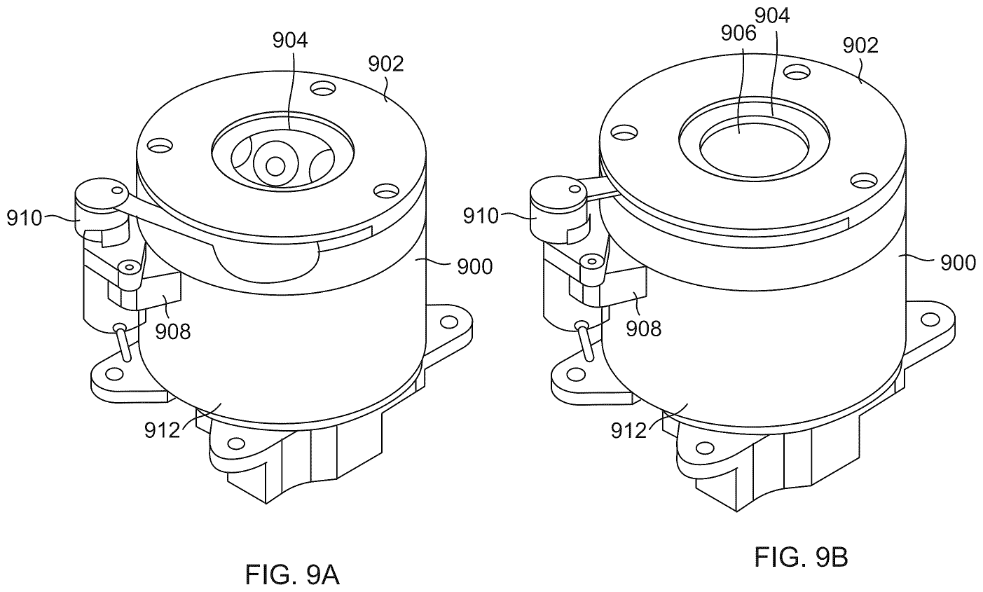

FIGS. 9A and 9B are diagrams illustrating an example of an optical head according to some aspects. The optical head 900 includes a top surface 902 within which an optical window 904 may be placed. As shown in FIG. 9A, in a sample measurement mode, input light is directed through the optical window 904 towards a sample (not shown) to obtain a sample measurement. As shown in FIG. 9B, in a reference measurement mode, a moveable reference flag 906 is moved beneath the optical window 904 to diffusely reflect the input light to obtain a reference measurement. For example, an actuator 910, such as a solenoid with internal coils can be configured to move the reference flag 906 in two directions. In some examples, as shown in FIGS. 9A and 9B, the actuator 910 may be attached to a bracket holder 908 that is part of a mechanical chassis 912 of the optical head 900. When the reference flag is open (e.g., the actuator moves the reference flag 906 away from the light path), as shown in FIG. 9A, the sample measurement (sample PSD) is captured. By contrast, when the reference flag is closed (e.g., the actuator moves the reference flag towards (into) the light path, as shown in FIG. 9B, the reference measurement (reference PSD) is captured.

Reference measurement enables removal of the spectral response of the spectrometer system and spectral baseline drifts through dividing the sample PSD by the reference PSD to obtain the sample spectrum. The reference measurement in diffuse reflection spectrometers is taken by a material with high reflectivity and flat spectral response within the band of interest. Thus, the reference flag 906 material and surface finish is important for accurate background measurements with adequate signal levels. Different materials, such as, for example, stainless steel, aluminum, or gold coated aluminum may be suitable for the reference flag 906. In addition, different surface finishes of the reference flag 906, including sandblasting and laser etching can increase the diffuse reflection of the flag surface to collect useful scattered light and minimize specular reflections. In some examples, the flag diameter is large enough to cover the light spot of the input light.

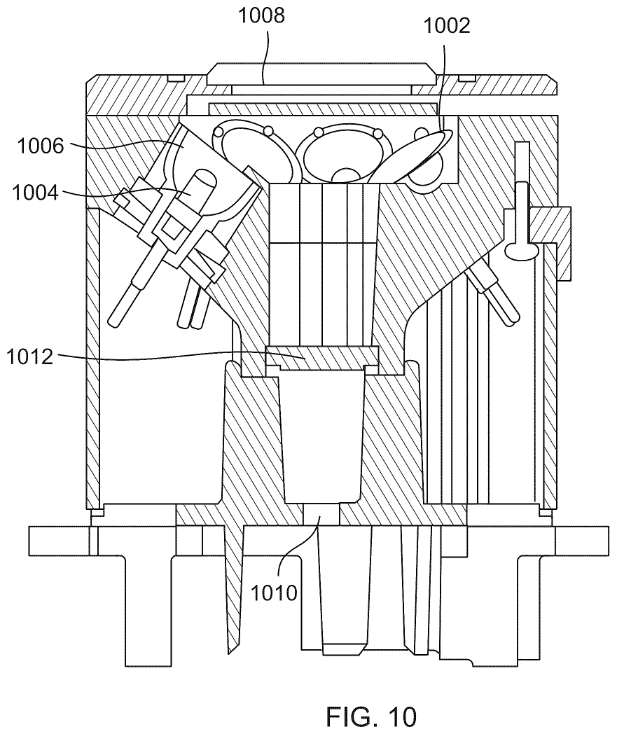

FIG. 10 is a diagram illustrating an example of illumination and collection components of the optical head according to some aspects. The optical head 1000 includes an illumination part 1002 (e.g., a light source unit) that includes a plurality of filament lamps 1004 assembled into reflectors 1006 to redirect input light from the filament lamps 1004 to a sample. An optical window 1008 is configured to hold the sample and to transmit light to the sample. The coating of the optical window 1008 may be optimized to allow for high transmission of the desired spectral ranges, while blocking undesired spectral ranges. In some examples, the optical window 1008 may be anti-reflection (AR) coated from both sides or from one side according to the application to prevent back specular reflected light from being input to a spectrometer aperture 1010. The aperture 1010 is configured to filter and block undesired light from entering the spectrometer as it is translated into a non-useful signal leading to low visibility at the spectrometer (e.g., OCM). The size and shape of the aperture 1010 can be designed to block the undesired light according to the spectrometer's numerical aperture. The optical head 1000 can further include a collection part 1012 that is configured to collect the diffuse reflected (e.g., scattered) light from the sample and to direct the diffuse reflected light to the aperture 1010.

The light source (illumination part) 1002 design can be configured to arrange the filament lamps 1004 and reflectors 1006 to focus the input light towards the sample above the optical window 1008 with some distance to account for the distance of the sample above the optical window 1008. In some examples, the light source can be designed and simulated using ray tracking tools to achieve the required specifications of illumination and collected power by the spectrometer.

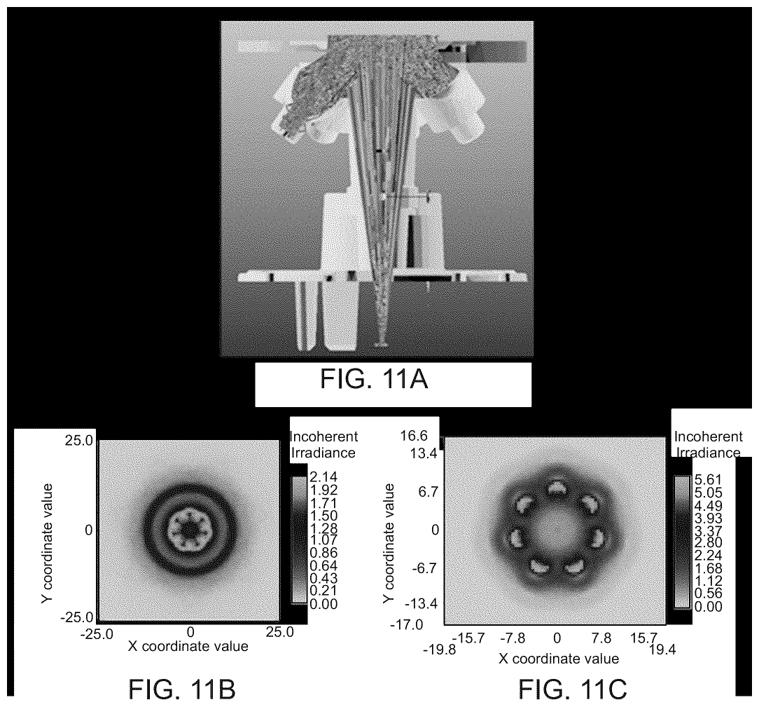

FIGS. 11A-11C illustrate an example of a simulated ray tracing of the source and corresponding illumination spots at the sample and the moveable reference flag according to some aspects. As shown in FIG. 11B, the illumination spot is overlapped at the sample resulting in the required spot shape and power. However, the spot at the reference flag, as shown in FIG. 11C, has a lower intensity near the center due to the separation of the reflectors, which makes the conditions of the sample and the flag measurements different. Thus, the optical power reaching the reference flag is different than the optical power reaching the sample. To compensate for the spectral response difference between the background reference PSD and the sample PSD, a compensation function can be provided as a Digital Signal Processing DSP-based calibration solution to provide accurate spectrum measurement. For example, the compensation function can be performed by the processor 220 shown in FIG. 2 or the processor 340 through the built-in reference compensation circuitry (or DSP block) 342 shown in FIG. 3. The compensation function may be generated by transferring the built-in reference measurement to another reference standard by calculating the ratio between the reference standard PSD and the built-in reference PSD to generate the compensation function (CF) that can be saved in the system memory (e.g., memory 348 shown in FIG. 3) to be used as a correction step with each reference measurement to produce a compensated (corrected) sample PSD as follows:

$$Corrected Spectrum = \frac{Sample PSD}{CF \times Built - in Reference PSD} where \qquad ( Equation 1 )$$

$$CF = \frac{Reference Standard PSD ( memory )}{Built - in Reference PSD ( memory )} \qquad ( Equation 2 )$$

Although the reference standard PSD is available in the system memory, the built-in reference measurement is used in the calculation of the sample spectrum to compensate for the temperature and humidity drift between the sample and the reference standard. In some examples, this correction step may be performed at the factory during production of the spectral sensor. However, the correction step can also be repeated at the customer side during runtime of the spectral sensor, as needed.

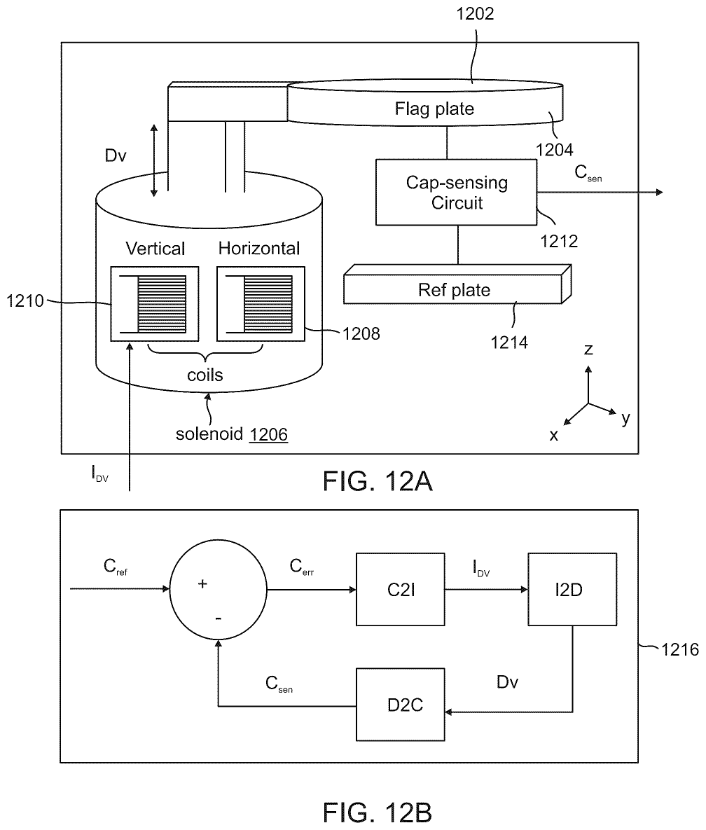

The built-in reference should be stable to guarantee spectral accuracy immunity against vibration and multiple operational cycles during the flag motion. Thus, vertical position of the reference flag may be crucial and sensitive. FIGS. 12A and 12B are diagrams illustrating an example of controlling the vertical position of a built-in moveable reference flag according to some aspects. A built-in moveable reference flag 1202 may be positioned on a flag plate 1204. Motion of the flag plate 1204 containing the reference flag 1202 in the horizontal (x-y) plane is controlled by a solenoid 1206 with horizontal coils 1208 to open or close the flag, as shown in FIG. 12A. One drawback of such a shutter is the possibility to change the vertical position of the flag 1202/flag plate 1204 along the z-axis during the operation in the x-y plane.

To overcome this issue, vertical coils 1210 can be added to the solenoid 1206 (or an additional solenoid with vertical coils 1210 can be added) to control the vertical distance (Dᵥ) accurately during the operation. In this scheme, a capacitive feedback system (feedback and conversion system) 1216 shown in FIG. 12B can be utilized to sense the capacitance (Cₛₑₙ), generated from the cap-sensing circuit 1212, between a fixed reference plate 1214 and the flag plate 1204, as shown in FIG. 12A. The sensed capacitance depends on the vertical distance (Dᵥ) from the relation:

$${C}_{sen} = \frac{ε A}{{D}_{y}} \qquad ( Equation 3 )$$

where ε is the permeability, and A is the common area between the flag plate 1204 and the reference plate 1214. As shown in FIG. 12B, the feedback and conversion system 1216 includes a block (C2I) to convert the error signal Cₑᵣᵣ between the sensed capacitance Cₛₑₙ and reference capacitance C_{ref} and generate the current (I_{DV}) to feed the solenoid 1206 for vertical controlling (e.g., using the vertical coils 1210). In this way, a generated electromagnetic force controls the vertical distance (D_{y}) of the flag 1202.

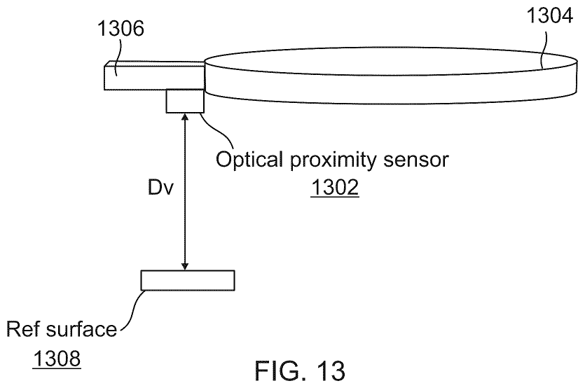

FIG. 13 is a diagram illustrating another example of controlling the vertical position of a built-in moveable reference flag according to some aspects. In the example shown in FIG. 13, an optical proximity sensor 1302 is utilized to control the vertical position of a built-in moveable reference flag 1304. The optical proximity sensor 1302 may be placed, for example, on a bottom side of an arm 1306 of the flag 1304 (or an arm of a flag plate containing the flag). The optical proximity sensor 1302 can be configured to sense the vertical distance (D_{y}) of the flag 1304 with respect to a reference surface 1308. The sensed vertical distance (D_{y}) can then be used to compensate or correct for a difference between the sensed vertical distance and a reference vertical distance.

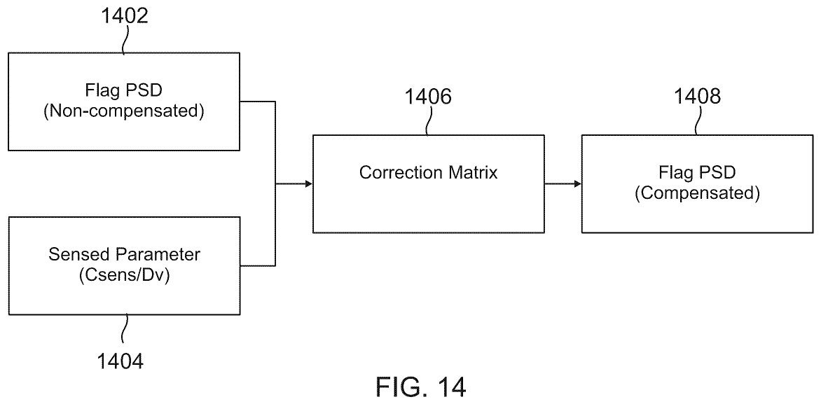

FIG. 14 is a diagram illustrating an example of correcting a reference PSD based on a sensed parameter of a vertical position of the built-in moveable reference flag according to some aspects. In some examples, the sensed parameter 1404 corresponds to the sensed vertical distance (D_{y}) shown in FIG. 13. In other examples, the sensed parameter 1404 corresponds to the sensed capacitance (Cₛₑₙ) shown in FIG. 12A. In examples in which the sensed parameter corresponds to the sensed capacitance, instead of including vertical coils 1210, as shown in FIG. 12A and a feedback and conversion system 1216 shown in FIG. 12B, correction may be performed during processing of the reference PSD (e.g., by the processor 220 shown in FIG. 2 or the processor 340 shown in FIG. 3). In the example shown in FIG. 14, a correction matrix 1406 can be extracted to compensate for different vertical distances as indicated by the sensed parameter 1404. The correction matrix 1406 may be stored, for example, in system memory (e.g., memory 348 shown in FIG. 3). The extracted correction matrix 1406 may be applied to the flag PSD 1402 obtained during the reference measurement mode to produce a compensated (corrected) flag PSD 1408.

Correction matrices may be used to correct for other types of drifts as well, such as thermal drifts. A determination of how frequent the reference (background) measurement is taken before the sample measurement is important to minimize the overhead time of background measurements, which is crucial for inline applications where the measurement speed is an important aspect. The most ideal scenario is to take a reference measurement before each sample measurement. In this way, thermal drift between the two measurements is minimized. However, this may not be suitable for many inline systems targeting real-time high-throughput measurements.

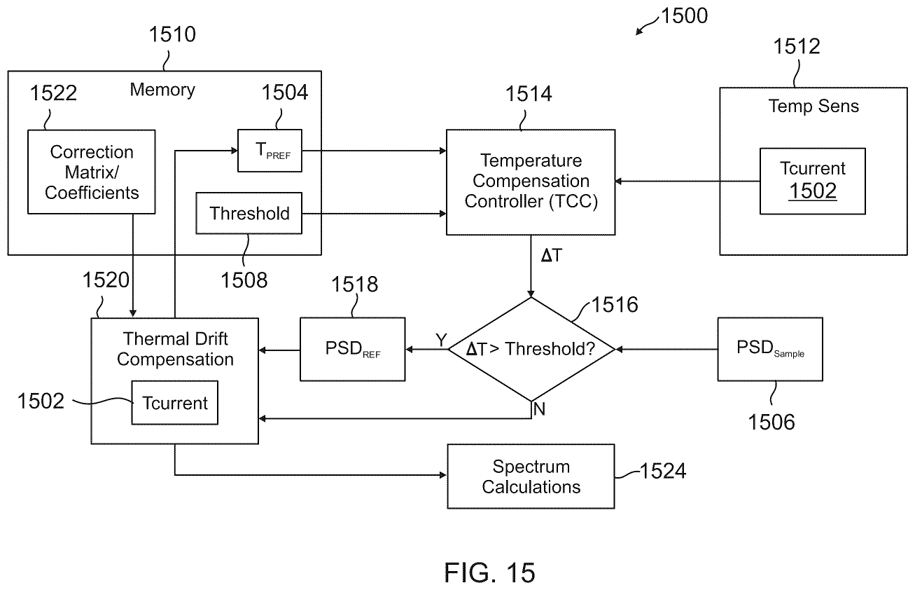

Therefore, in other scenarios, with reference to FIG. 15, the reference measurement may be taken only if the temperature difference (ΔT) between a current temperature (T_{current}) 1502 of a current sample measurement (PSD_{Sample}) 1506 and a previous temperature (T_{PREV}) 1504 associated with a previous (e.g., the last prior) reference measurement exceeds a threshold 1508. In the example shown in FIG. 15, each of the previous (last) reference temperature (T_{PREV}) 1504 and the threshold 1508 may be stored, for example, in system memory 1510 (e.g., which may correspond to memory 348 shown in FIG. 3). FIG. 15 further illustrates an algorithm 1500 that updates parameters for temperature compensation based on whether the temperature difference (ΔT) exceeds the threshold 1508.

One or more temperature sensors 1512 can be configured to obtain the current temperature (T_{current}) 1502 associated with the current sample measurement 1506 and to provide the current temperature 1502 to a temperature compensation controller (TCC) 1514. In some examples, the TCC 1514 may be implemented by the performance monitoring circuitry 354 shown in FIG. 3 or the temperature compensation circuitry 344 shown in FIG. 3. The TCC 1514 is configured to compare the current temperature (T_{current}) 1502 to the stored previous temperature (T_{PREV}) 1504 to determine a temperature difference (ΔT) between the current temperature 1502 and the stored previous temperature 1504. The TCC 1514 is further configured at block 1516 to determine whether the temperature difference (ΔT) exceeds the threshold 1508.

If the temperature difference does exceed the threshold (Y branch of block 1516), at block 1518, a new background reference measurement (PSD_{REF}) may be taken and thermal drift compensation can be performed at block 1520. If the temperature difference does not exceed the threshold (N branch of block 1516), thermal drift compensation can be performed at block 1520 using a last measured reference PSD (PSD_{REF}). Thermal drift compensation at block 1520 can be performed by calculating the respective y-axis (power/intensity) thermal drift (ay) of each of the background (reference) measurement PSD_{REF} (e.g., new or last measured PSD_{REF}) and the current sample measurement (PSD_{Sample}) 1506 through referring the PSDs at the current temperature (PSD(T)) to a certain reference temperature T_{REF} as follows:

$${α}_{y} ( T ) = \frac{PSD ( T )}{PSD ( {T}_{REF} )} \qquad ( Equation 4 )$$

In some examples, the thermal drift (ay) can be calculated using a correction matrix 1522 stored in the system memory 1510. For example, the thermal drift may be calculated at block 1520 by the temperature compensation circuitry 344 shown in FIG. 3. The correction matrix can be obtained by calculating the coefficients of polynomial fitting across the wavenumber vector of the PSDs. The fitting is done using discrete temperature readings (independent variable) and their corresponding drift (dependent variable). The corrected PSDs (correct PSD_{REF} and corrected PSD_{Sample}) are then obtained at the thermal drift compensation block 1520 through dividing the non-corrected PSDs by the drift at the current temperature:

$${PSD}_{corrected} = \frac{{PSD}_{non - corrected} ( T )}{{α}_{y - fit} ( T )} where \qquad ( Equation 5 )$$

$${α}_{y - fit} ( T ) = {a}_{0} + {a}_{1} T + {a}_{2} {T}^{2} + ⋯ + {a}_{k} {T}^{k} \qquad ( Equation 6 )$$

where k represents the fitting order and a₀, a₁, . . . , aₖ are the polynomial fitting coefficients.

In a similar way, the thermal drift compensation block 1520 (e.g., as executed by the temperature compensation circuitry 344 shown in FIG. 3) can correct the wavelength shift (x-axis thermal drift) by multiplying the wavenumber vector (wavelength=1/wavenumber) by at least one wavenumber correction factor 1522 calculated according to the current temperature. The wavenumber correction factor(s) 1522 represent the polynomial coefficients (C) obtained from a linear regression process. The wavenumber correction factor(s) 1522 corresponding to the polynomial coefficients may be stored, for example, in system memory 1510. The linear regression can be performed using the measured (n) peaks (P_{M}=[p_{M1}, p_{M2}, . . . , P_{Mn}]^{T}) of a standard material versus the reference locations of these peaks in the reference PSD (P_{REF}=[p_{REF1}, p_{REF2}, . . . , p_{REFn}]^{T}) as follows:

$$A = [ 1 {P}_{M} {P}_{M}^{2} , … , {P}_{M}^{j} ] \qquad ( Equation 7 )$$

$$B = A \cdot {P}_{REF} \qquad ( Equation 8 )$$

$$C = {( A \cdot A )}^{- 1} \cdot B = [ {c}_{0} , {c}_{1} , … , {c}_{j} ] \qquad ( Equation 9 )$$

where P_{M} and P_{REF} represent column vectors of size n-by-1, and j represents the regression order>0. If the regression order=0, A=[P_{M}]. In order to compensate for the x-axis drift across temperature, the wavenumber correction factors are multiplied at the thermal drift compensation block 1520 by a gain error (αₓ) that represents the average thermal drift of the measured peaks to a certain reference temperature T_{REF}:

$${α}_{x} ( T ) = \frac{1}{n} \times ( \frac{{p}_{M 1} ( {T}_{REF} )}{{p}_{M 1} ( T )} + \frac{{p}_{M 2} ( {T}_{REF} )}{{p}_{M 2} ( T )} + ⋯ + \frac{{p}_{Mn} ( {T}_{REF} )}{{p}_{Mn} ( T )} ) \qquad ( Equation 10 )$$

In a similar way, polynomial fitting is needed to extract a relation between ax verses temperature and correct the wavenumber accordingly as follows:

$${WVN}_{corrected} = {α}_{x - fit} ( T ) \times ( {c}_{0} + {c}_{1} {WVN}_{non - corrected} + ⋯ + {c}_{j} {WVN}_{non - corrected}^{j} ) where : \qquad ( Equation 11 )$$

$${α}_{x - fit} ( T ) = {b}_{0} + {b}_{1} T + {b}_{2} {T}^{2} + ⋯ + {b}_{k} {T}^{k} \qquad ( Equation 12 )$$

where k represents the fitting order, and b₀, b₁, . . . , bₖ are the polynomial fitting coefficients.

Once thermal drift compensation for y-axis or both y-axis and x-axis is performed, at block 1524, a sample spectrum may be calculated (e.g., based on one or more spectrum calculations, as described herein). For example, the sample spectrum may be obtained by dividing the corrected sample spectrum by the last measured reference PSD if the temperature difference (ΔT) is less than the threshold or by dividing the corrected sample spectrum by a new measured reference PSD if the temperature difference (ΔT) exceeds the threshold.

The process of correcting the drift in both x and y axes requires discrete temperature readings and the corresponding measurements of the standard references. These standard measurements can be done at the factory by performing temperature sweeping across certain temperature range (−10° C. to 60° C. for example). Then all the extracted matrices/coefficients 1522 are saved on the system memory 1510 to be used for correction during DSP operation. The extracted matrices/coefficients 1522 mainly depend on the optical core module (OCM), so optical head replacement does not affect these matrices as long as the sensor board module is still the same. In some examples, temperature readings may be obtained using integrated temperature sensors on the sensor board itself.

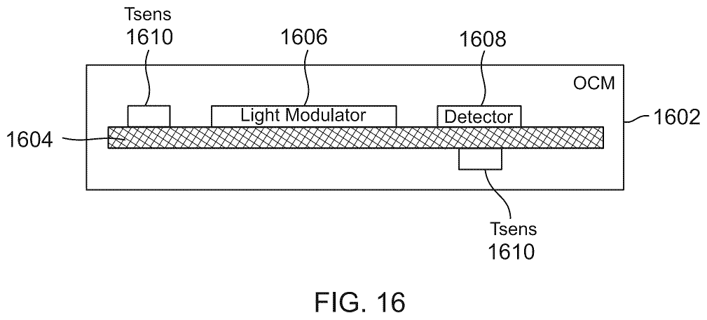

FIG. 16 is a diagram illustrating an example of integrated temperature sensors according to some aspects. Integrated temperature sensors 1610 may be configured to measure the temperature of a detector 1608 (photodetector) and an optical core module (OCM) chip 1602 that includes a light modulator 1606 and the detector 1608 during the operation of the spectral sensor system. For example, analog integrated circuit (IC) temperature sensors 1610 may be integrated on a sensor board 1604 of the OCM 1602 to monitor the detector temperature to capture temporal and spatial effects during measurements to compensate for thermal drift. In some examples, the temperature sensors 1610 may be based on semiconductor technology that provides the system with linearity, accuracy and sensitivity, with low power consumption and simplicity of system-level integration as compared to other technologies, e.g. thermistors and RTD (Resistance Temperature Detector), which require careful excitation, signal conditioning, and interfacing. As shown in the example of FIG. 16, the temperature sensors 1610 can be integrated into the spectral sensor in two different places: one is underneath the detector 1608 at the backside of the sensor board 1604 to monitor spatial thermal effect and the other is on the upper side of the sensor board 1604 away from the detector 1608 to measure the temperature across the OCM 1602.

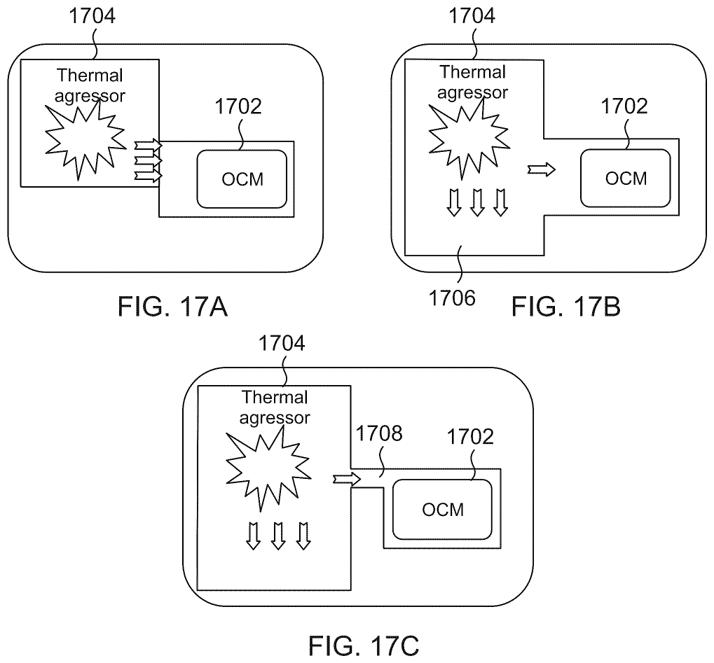

FIGS. 17A-17C are diagrams illustrating an example of dissipating heat from thermal aggressors according to some aspects. In the example shown in FIG. 17A, a thermal aggressor 1704 is positioned near an OCM 1702 (e.g., on the sensor board containing the OCM 1702). To enhance (or reduce) the thermal variations of the detector of the OCM 1702, as can be seen in FIG. 17B, the thermal aggressor 1704 may be kept away from the detector by increasing (or extending) a copper area 1706 under the thermal aggressor 1704 at the layout level to dissipate heat away from the OCM 1702. In the example shown in FIG. 17C, shared copper 1708 that is shared between the OCM 1702 and the thermal aggressor 1704 is reduced to shrink the temperature dissipation area between the thermal aggressor 1704 and the OCM 1702 in order to further enhance (reduce) the thermal variation at the detector of the OCM 1702.

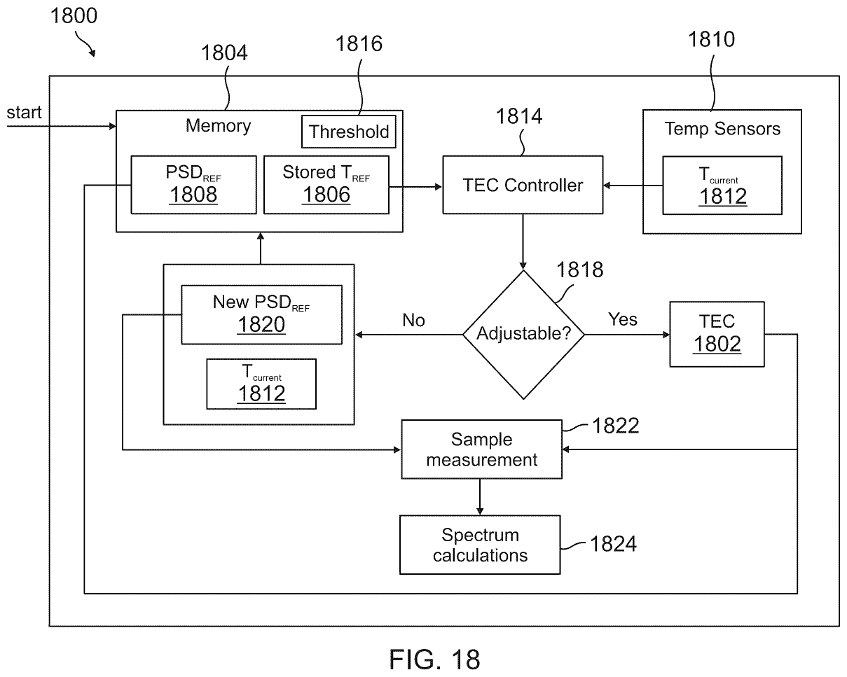

FIG. 18 is a diagram illustrating an example of thermal stabilization of an optical core module (OCM) according to some aspects. In the example shown in FIG. 18, thermal drift can be accommodated using thermal stabilization employing a Thermo-Electric Cooling TEC system 1802. TEC 1802 can be used to cool the photodetector to improve the SNR of the spectral sensor; however it can be also used for temperature stabilization around certain reference temperature. For example, the reference temperature may be set to be close to room temperature (e.g., 25° C.) or slightly higher to account for self-heating of the system. For spectral systems that are used in a wide range of ambient temperatures, achieving temperature stabilization can be challenging, as maintaining the core components temperature fixed at a certain reference temperature may require a bulky TEC system for proper heat dissipation and large power consumption.

Therefore, as shown in FIG. 18, temperature stabilization can be applied to maintain the system temperature at the same reference temperature (T_{REF}) 1806 of a last measured background PSD (PSD_{REF}) 1808. Each of the previous (last) reference temperature (T_{REF}) 1806 and the associated last measured background PSD (PSD_{REF}) 1808 may be stored, for example, in system memory 1804 (e.g., which may correspond to memory 348 shown in FIG. 3). FIG. 18 further illustrates an algorithm 1800 that utilizes the TEC 1802 to minimize the temperature difference (ΔT) between the current ambient temperature (T_{current}) 1812 of the core sensor module (e.g., optical core module (OCM) of the core sensor module) and the reference background temperature (T_{REF}) 1806 measured at the time of the previous (last) reference measurement (PSD_{REF}) 1808, which are stored in the system memory 1804

One or more temperature sensors 1810 can be configured to obtain the current temperature (T_{current}) 1812 and to provide the current temperature 1812 to a TEC controller 1814. In some examples, the TEC controller 1814 may be implemented by the performance monitoring circuitry 354 shown in FIG. 3 or the temperature stabilization circuit 330 shown in FIG. 3. The TEC controller 1814 is configured to compare the current temperature (T_{current}) 1812 to the stored reference temperature (T_{REF}) 1806 to determine a temperature difference (ΔT) between the current temperature 1812 and the stored reference temperature 1806. Temperature stabilization is applicable if ΔT is below a certain threshold 1816 (e.g., which may also be stored in the memory 1804 and accessed by the TEC controller 1814). The threshold 1816 may be determined, for example, by the capability of the TEC system. If the temperature difference (ΔT) is less than the threshold 1816, at block 1818, the TEC controller 1814 can determine that temperature stabilization can be performed by the TEC 1802 (e.g., as indicated by the Y branch of 1818). The TEC 1802 then performs temperature stabilization around the stored reference temperature (T_{REF}) 1806, and at blocks 1822 and 1824, a new sample measurement may be taken by the spectral sensor and a new sample spectrum may be calculated (e.g., based on one or more spectrum calculations, as described herein).

Otherwise, if the temperature difference (ΔT) is less than the threshold 1816, at 1816, the TEC controller 1814 can determine that a new reference background (New PSD_{REF}) measurement should be taken at block 1818 and stored in the memory 1804 as the reference (PSD_{REF}) 1808, along with the current temperature (T_{current}) 1812 to be stored as the new reference temperature (T_{REF}) 1806. In some examples, the threshold 1816 can be decided according to the speed of the TEC controller 1814 to force T_{current} to be as close as possible to the stored T_{REF} with minimum error. After obtaining a new reference background measurement (New PSD_{REF}), a new sample reading is captured at block 1822 to calculate the final (corrected) spectrum at block 1824.

In other examples, TEC may be used in conjunction with and before applying the correction matrix algorithm 1500 shown in FIG. 15 if the allowed temperature difference between the sample PSD and the background/reference PSD is relatively large exceeding an allowed threshold margin. In this example, the TEC controller 1814 alone or the correction matrix alone may be not enough to thermally stabilize the spectral response accurately. Ideally, a TEC-stabilized system does not require any compensation of thermal drift to be applied as it controls the temperature of the sensitive components of the system. However, if the TEC fails to stabilize the temperature within the target margins when the ambient temperature or system self-heating exceeds TEC system capabilities, the TEC target temperature can be changed (e.g., the sensor can automatically change the target TEC temperature) and the background flag can be scanned automatically to correct for any thermal drifts. Furthermore, a hybrid solution having both the TEC and temperature compensation matrix can relax the allowed margins of TEC temperature control deviations and assure the spectral stability of the system.

Although temperature sensors may be utilized to aid in compensation for the thermal drift, in other examples, the wavelength detector cut-off point can be used to map to the temperature. By using the wavelength detector cut-off point, this can eliminate the need to integrate temperature sensors into the spectral system.

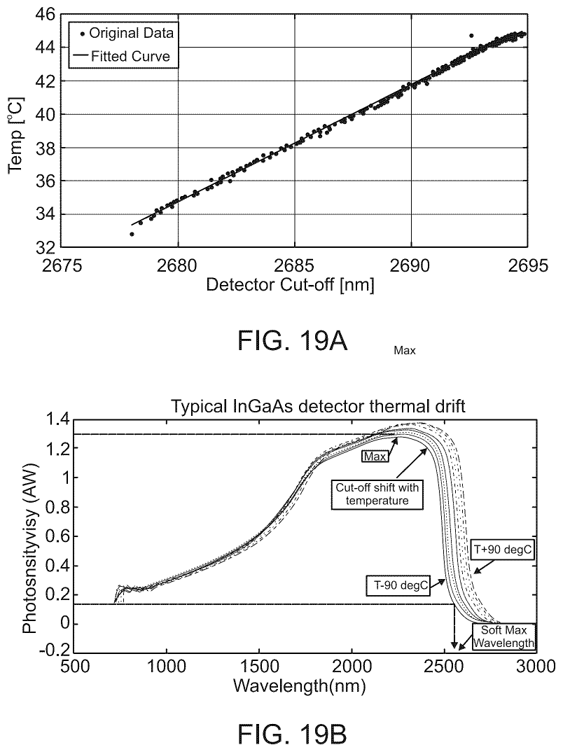

FIGS. 19A and 19B illustrate an example of wavelength detector cut-off points according to some aspects. FIG. 19A illustrates exemplary wavelength detector cut-off points (in nanometers (nm)) versus temperature. FIG. 19B illustrates exemplary thermal drift of a detector to show how the wavelength detector cut-off point varies with temperature. The detector cut-off can be defined as the wavelength at which the signal power reaches 10% of the maximum power. In order to obtain a relation (mapping) between the wavelength detector cut-off points and corresponding temperatures (as shown in FIGS. 19A and 19B, discrete temperature readings of the detector can be taken using a highly accurate temperature sensor simultaneously to obtain discrete reference measurements (e.g., using the built-in reference flag) to identify the corresponding cut-off wavelengths for each discrete temperature. The temperature sensor may not be integrated into the system, but rather can be used only once during production to obtain the mapping. Polynomial fitting can also be used to extract a relation of the detector temperature (T) versus the cut-off wavelength (WVL_{cut-off}) as follows:

$$T = {d}_{0} + {d}_{1} {WVL}_{cut - off} \qquad ( Equation 13 )$$

where d₀, d₁ represent the 1^{st} order fitting coefficients. In some examples, no higher order coefficients are required as the relation between the detector cut-off wavelength and detector temperature is almost a linear relation with some offset, as can be seen in FIGS. 19A and 19B.

In some examples, the fitting coefficients can be stored on the system memory (e.g., memory 348 shown in FIG. 3 or memory 1804 shown in FIG. 18) to be used during temperature compensation of the reference/sample PSD (e.g., as performed by the temperature compensation circuitry 344 shown in FIG. 3) or by the TEC controller 1814 shown in FIG. 18 to identify the current temperature (T_{current}). In case there is enough memory storage, a Look-Up Table (LUT) can be saved to map the cut-off wavelengths to the corresponding temperature readings. This can eliminate the need of temperature sensors as hardware components that are integrated to the system. However, it requires materials with almost flat response to determine the cut-off wavelength precisely. In some examples, the built-in reference flag can be the best automated choice of the flat response material requiring background measurement before each sample measurement to estimate the detector temperature associated with these readings.

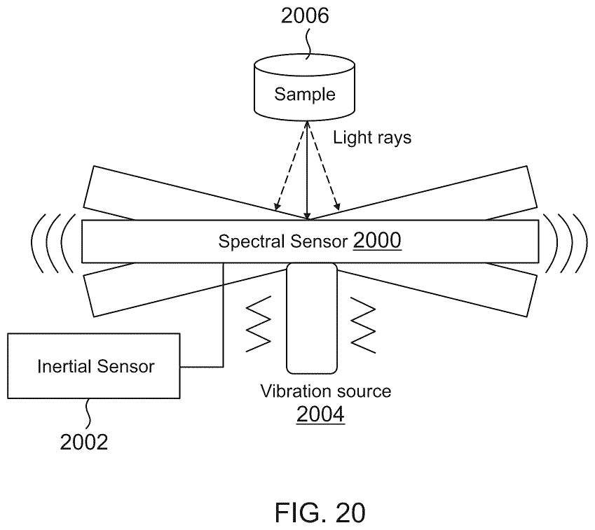

Beside thermal drift compensation, inertial sensors can be included in the spectral sensor to compensate for displacement and misalignment of the spectral sensor during the measurements. This may be essential for systems operating in harsh vibrational conditions. FIG. 20 is a diagram illustrating an example of a spectral sensor 2000 including an inertial sensor 2002 according to some aspects. An inertial sensor 2002 can be attached to a spectral sensor 2000 to transduce inertial forces into electrical signals in order to measure the accelerations and the angular rates experienced by the spectral sensor 2000. The inertial sensor 2002 can include, for example, one or more of an accelerometer or a gyroscope. Inertial sensors that sense linear acceleration are referred to as accelerometers, whereas inertial sensors that sense the angular motion are referred to as gyroscopes. A single accelerometer or gyroscope can be capable of measuring the associated quantity along one axis. External perturbations produced by a vibration source 2004 can cause displacement and/or tilting of the spectral sensor 2000 resulting in a misalignment between a sample 2006 and the sensor 2000. The misalignment affects the penetration depth of the light beam through the sample 2006 and the amount of reflected power thereof, resulting in repeatability problems. The inertial sensor 2002 can be configured to detect the tilt angle or/and displacement between the sample 2006 and the spectral sensor 2000, and then perform a correction step accordingly.

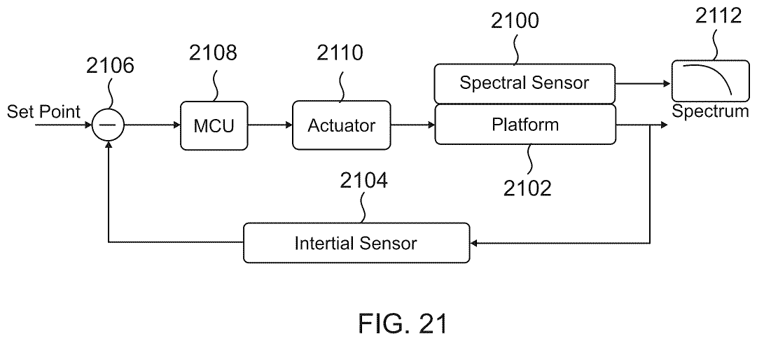

FIG. 21 is a diagram illustrating an example of correcting misalignments caused by a perturbation source according to some aspects. In the example shown in FIG. 20, a spectral sensor 2100 is positioned on a platform 2102 which has an angle with respect to the horizontal axis. An inertial sensor 2104 can be configured to sense an inertial force based on a current angle of the platform 2102 and feedback the inertial force measurement to a microcontroller unit (MCU) 2108 (e.g., a processor such as the processor 220 shown in FIG. 2 or the processor 340 shown in FIG. 3), which compares the inertial force to a required set point 2106 and sends a control signal to an actuator 2110 coupled to the platform 2102 to adjust the angle of the platform 2102 with respect to the horizontal axis prior to obtaining a sample PSD 2112. In some examples, the adjustment/correction is done in case the drift is within the system capability, otherwise the reading is rejected.

Instead of adjusting/correcting the platform angle, another approach to correct for the tilting and misalignments can use a pre-calculated Look-Up Table LUT (not shown, but could be included, for example, in memory 348 shown in FIG. 3) that contains each tilted angle or/and distance corresponding to a change in the light intensity. The MCU 2108 (e.g. processor) can then correct the current sample PSD 2112, so that the effect of the vibrations is not presented in a corrected spectrum of the sample.

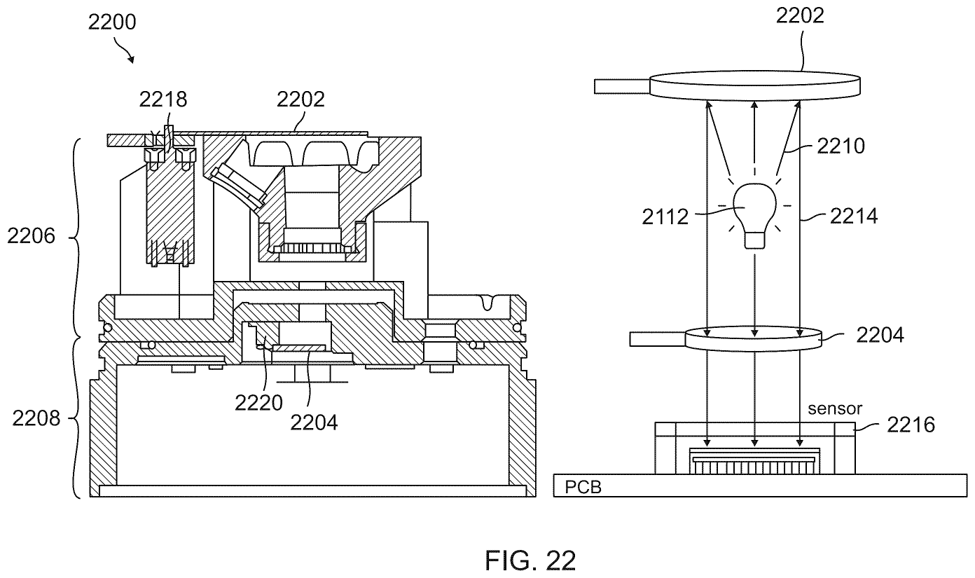

FIG. 22 is a diagram illustrating an example of a spectral sensor including a moveable wavelength calibration flag according to some aspects. In the example shown in FIG. 22, the spectral sensor 2200 includes a built-in moveable reference flag 2202 located in an optical head 2206 of the spectral sensor 2200 and a built-in moveable wavelength-calibration flag 2204 located in the core sensor module 2208 of the spectral sensor 2200. The built-in moveable wavelength calibration flag 2204 is used for automatic wavelength correction by modifying the incident light spectrum to absorb certain wavelength bands/peaks. In some examples, the built-in moveable wavelength calibration flag 2204 is an optical filter or any material (e.g., plastic, etc.) with specific reference absorption bands.

For example, as shown in FIG. 22, input light 2210 generated by a light source 2212 is diffusely reflected from the moveable reference flag 2202 in the combined reference/wavelength calibration mode (e.g., when the reference flag 2202 is in the first position beneath the optical window and within the light path of the input light 2210). Reflected light 2214 from the built-in reference flag 2202 (Rx flag) is transmitted through the wavelength-calibration flag (Tx flag) 2204 and then coupled towards the optical core module 2216 of the core sensor module 2208. Thus, in the combined reference/wavelength calibration mode, the wavelength calibration flag 2204 is also in the first position within the light path of the reflected light 2214. The designed position of the wavelength calibration flag 2204 is below the light source 2212 and above the optical core module 2216 (e.g., above the light modulator of the OCM), as shown in FIG. 22. In some examples, the wavelength-calibration flag 2204 can be a transparent polystyrene flag or a narrow band-pass optical filter. The transparent polystyrene sheet or the filter can be in the form of a regular shape, such as a circular disc integrated to a flag with a circular opening.

Each of the built-in reference flag 2202 and the built-in wavelength-calibration flag 2204 are controlled by a separate respective actuator (e.g., solenoid) 2218 and 2220, to move the respective flags 2202 and 2204 back and forth between the corresponding first positions or second positions according to the applied mode. In some examples, the actuators 2218 and 2220 each receive a respective signal from a driving circuit in, for example, a control unit within the core sensor module 2208, depending on the measurement state. For a background/reference only measurement in the reference measurement mode, only the built-in background reference flag 2202 (intensity-calibration) is moved towards the light path (i.e. flag closed). Here, the wavelength calibration flag 2204 is moved away from the light path (i.e. flag opened). For a sample measurement in the sample measurement mode, both flags 2202 and 2204 are moved away from the light path (i.e. both flags opened). For a reference/wavelength-calibration measurement in the combined reference/wavelength calibration mode, both flags 2202 and 2204 are moved simultaneously towards the light path; the reference flag 2202 is closed to reflect the light towards the wavelength calibration flag 2204. The wavelength-calibration flag then receives this light and modifies its spectrum before reaching the OCM.

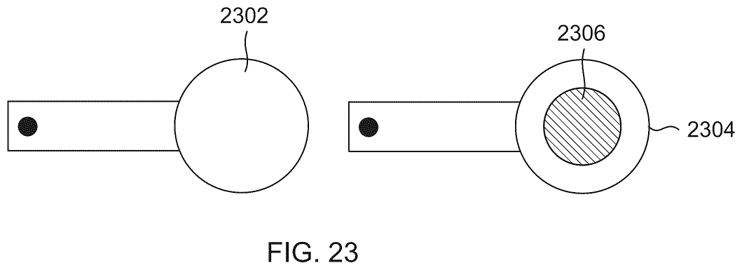

FIG. 23 is a diagram illustrating an example of built-in flags according to some aspects. In the example shown in FIG. 23, a built-in moveable reference flag 2302 may operate simultaneously with a built-in moveable wavelength calibration flag 2304 using reflection mode Rx for the built-in reference flag 2302 and transmission mode Tx for the built-in wavelength-calibration flag 2304. The wavelength calibration flag 2304 may include, for example, a circular disc of wavelength-absorbing material or a filter integrated inside an opening 2306 in the flag 2304.

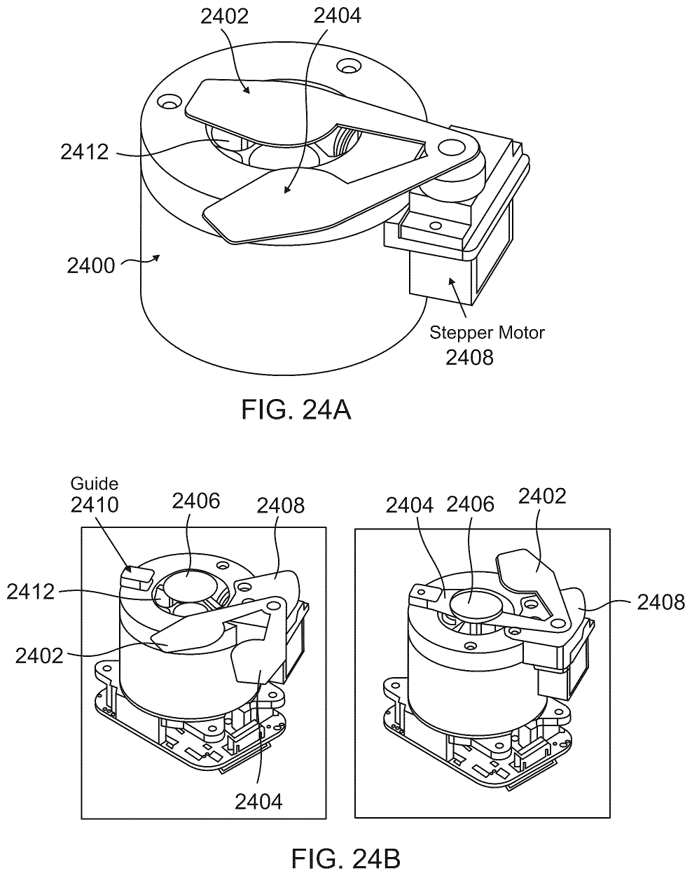

FIGS. 24A and 24B are diagrams illustrating another example of a spectral sensor including a moveable wavelength calibration flag according to some aspects. In the example shown in FIGS. 24A and 24B, a built-in moveable reference flag 2402 and a built-in moveable wavelength calibration flag 2404 are both located in an optical head 2400 of a spectral sensor. In this configuration, the light is trans-reflected or diffuse-reflected from the wavelength-calibration flag 2404 towards the optical core module (not shown). The designed position of the wavelength calibration flag 2404 is above a light source 2412 of the optical head 2400 and below an optical window 2406, while being on the same horizontal plane as that of the reference flag 2402. In this example, the wavelength calibration flag 2404 can be made of polystyrene material or any suitable standard material. The flags 2402 and 2404 can be controlled by a single actuator 2408 (e.g., stepper motor) as shown in FIG. 24B, where the two flags 2402 and 2404 are guided with a guide 2410 on the other side of the light source 2412 opposite to the stepper motor 2408. The actuator 2408 receives a control signal from a driving circuit in the control unit (e.g., the processor 220 shown in FIG. 2 or the processor/control unit(s)/power management system 340 shown in FIG. 3), depending on the measurement state. For a reference (background/intensity) measurement in the reference measurement mode, the built-in reference flag 2402 is moved towards the light path. For a sample measurement in the sample measurement mode, both flags 2402 and 2404 are moved away from the light path. For a wavelength calibration measurement in the wavelength calibration mode, the built-in wavelength-calibration flag 2404 only is moved towards the light path. Thus, the actuator 2408 can move the reference flag 2402 towards the light path at a first time to obtain a reference (intensity) measurement (e.g., a reference PSD) and can then move the wavelength calibration flag 2404 towards the light path to obtain a wavelength measurement (e.g., a wavelength PSD) at a second time that can be used (e.g., by the processor 220/340) to correct the wavelength of the sample and reference PSDs using mainly the wavelength calibration measurement of the wavelength PSD, then correct the intensity (y-axis) of the wavelength-corrected sample PSD using mainly the reference measurement (wavelength-corrected reference PSD) to produce the corrected sample spectrum.

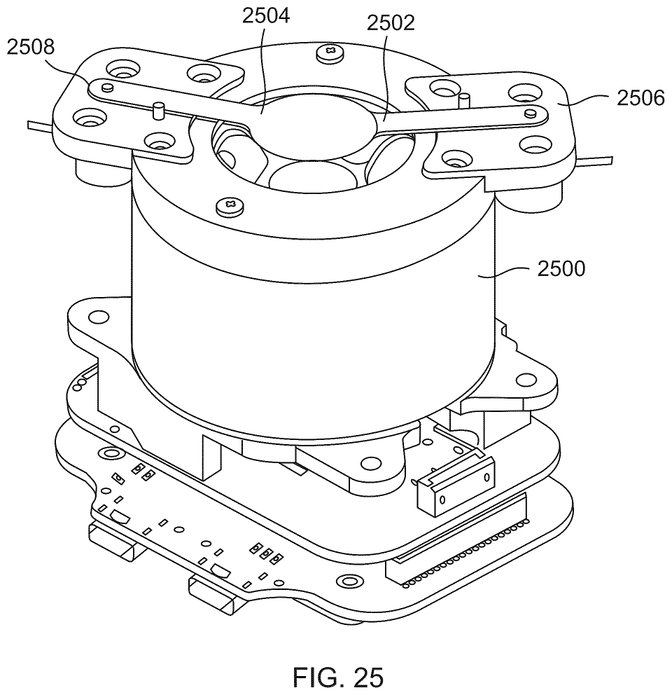

FIG. 25 is a diagram illustrating another example of a spectral sensor including a moveable wavelength calibration flag according to some aspects. In the example shown in FIG. 25, a built-in moveable reference flag 2504 and a built-in moveable wavelength calibration flag 2502 are both located in an optical head 2500 of a spectral sensor. However, instead of a single actuator to control each flag 2502 and 2504 separately, the optical head can employ two actuators (e.g., solenoids) 2508 and 2506 to control the motion of each flag separately. For a reference (background/intensity) measurement in the reference measurement mode, the built-in reference flag 2504 is moved towards the light path via actuator 2508. For a sample measurement in the sample measurement mode, both flags 2502 and 2504 are moved away from the light path via actuators 2506 and 2508. For a wavelength calibration measurement in the wavelength calibration mode, in case of using a reflective wavelength-calibration flag, the built-in wavelength-calibration flag 2502 only is moved towards the light path via actuator 2506. For example, the actuator 2508 can move the reference flag 2504 towards the light path at a first time to obtain a reference (intensity) measurement (reference PSD). The actuator 2506 can then move the wavelength calibration flag 2502 towards the light path to obtain a wavelength measurement at a second time that can be used (e.g., by the processor 220/340) to correct the wavelength of the sample and reference PSDs and generate a corrected sample spectrum. In another example, a transmission-based wavelength calibration flag 2502 can be used, such that in a combined reference/wavelength calibration mode, both flags 2502 and 2504 are moved by actuators 2506 and 2508 towards the light path, where the wavelength calibration measurement is performed in a trans-reflection configuration.

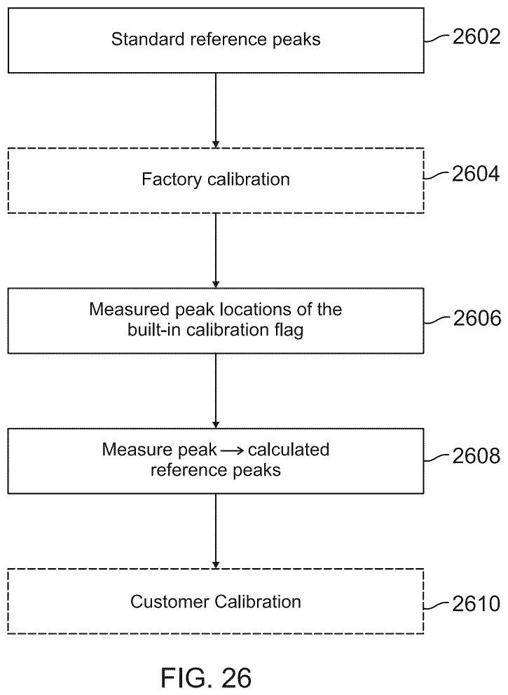

FIG. 26 is a diagram illustrating an example flow of various calibrations performed from the factory to the inline operation at the customer side according to some aspects. The correction method using the wavelength-calibration flag depends on the initial calibration performed at the factory at block 2604. For example, the wavelength calibration process described by Equations (7-9) can be performed at the factory at block 2604 using certified reflection-based standard reference materials with multiple peaks across the spectra range provided at block 2602. In some examples, the certified reference materials can be measured at the same location of the sample to calibrate the system for the best accuracy. Then, at block 2606, the wavelength peak locations of the built-in wavelength-calibration flag can be measured and saved on the system memory to be the reference peaks for the built-in wavelength correction to be performed later on during operation at the customer side at block 2608. At block 2610, at the customer side, a wavelength calibration algorithm (e.g., as executed by the wavelength correction circuitry 346 shown in FIG. 3) can again apply Equations (7-9) each time the wavelength calibration is performed using the reference peaks saved into the memory.

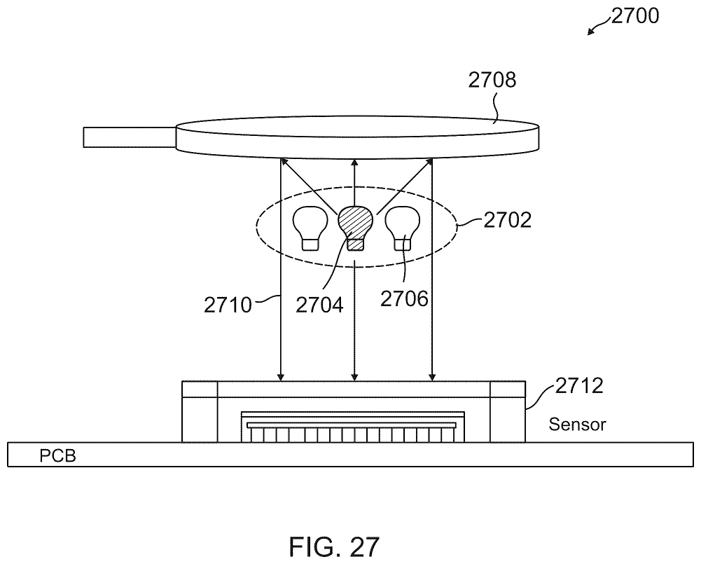

FIG. 27 is a diagram illustrating an example of wavelength self-calibration according to some aspects. In the example shown in FIG. 27, a light source 2702 within a spectral sensor 2700 includes a light emitting diode (LED) 2704 of specific wavelength in the operating spectral range of the sensor 2700 along with a built-in reference background flag 2708 above the light source 2702 (and below the optical window, not shown). In some examples, the light source 2702 includes one light source reflector holder (not shown) dedicated for the calibration LED 2704 with its own control signal to switch on and off the LED 2704. For example, during the calibration process, the built-in reference flag 2708 can be moved towards the light path while the LED lamp 2704 is turned on and other light-emitting sources 2706 (e.g. lamps or LEDs) are turned off (e.g., via a separate control signal). Reflected light 2710 from the built-in reference flag 2708 carries the information of the peak location of the LED 2704 that is processed by the core sensor module 2712. If a wavelength error is detected by the core sensor module 2712, the wavelength axis (x-axis) can be corrected/calibrated, depending on the reference peak location of the LED emission. In some examples, instead of using an LED lamp, one or more filament-based light bulbs with special coating films forming a narrow-band optical filter can be used to act as an effective narrow band light bulb for wavelength calibration/correction.

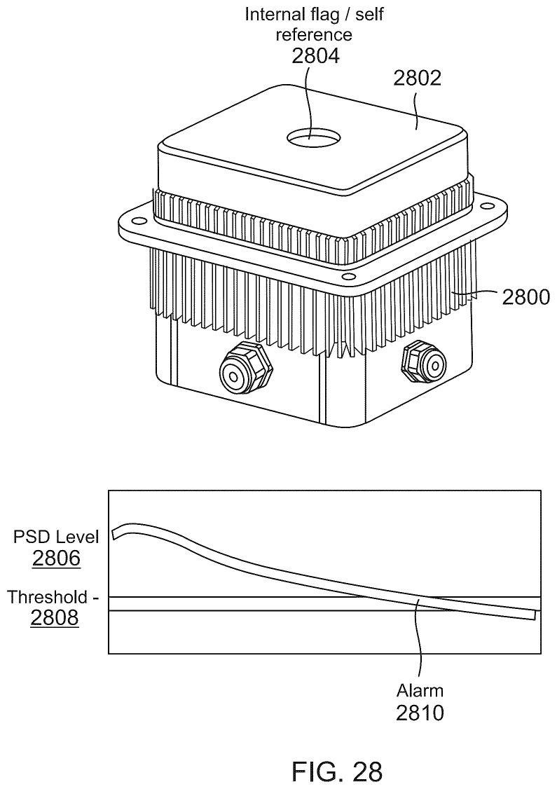

FIG. 28 is a diagram illustrating an example of criteria for optical head replacement according to some aspects. In the example shown in FIG. 28, the inline spectral sensor 2800 is designed such that the optical head 2802 of the sensor 2800 can be replaced when the light source lamps are not radiating enough power. For example, the performance monitoring circuitry 354 shown in FIG. 3 may perform self-referencing of the spectral sensor 2800 to test various specifications (e.g., SNR, repeatability, etc.) when the spectral sensor 2800 is turned on (powered on) and may further perform other self-referencing procedures to correct drifts in the sample PSD (e.g., that may occur due to environmental variations affecting the spectral sensor 2800) and to monitor performance of the light source periodically thereafter. For example, the performance monitoring circuitry 354 may call one or more self-referencing routines (algorithms/software) for y-axis correction prior to every sample or based on a current temperature of the spectral sensor, as described above. In addition, the performance monitoring circuitry 354 may call one or more wavelength calibration routines for x-axis correction periodically (e.g., once daily). Furthermore, the performance monitoring circuitry 354 may call one or more performance monitoring routines to check the intensity/power levels of the light source (e.g., using the reference flag 2804 or a performance monitoring kit (PMK)) daily, weekly, monthly, or other periodicity. If the PSD level (power) 2806 of a background/reference measurement falls below a threshold 2808 (e.g., indicating the light source power has significantly reduced), the performance monitoring circuitry 354 may provide an alarm 2810 (e.g., an alarm signal) to the customer to replace the optical head 2802 or the light source in the optical head 2802.

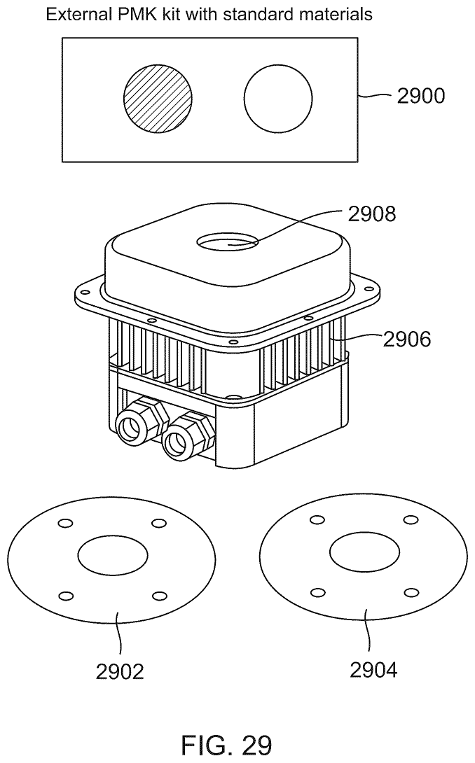

FIG. 29 is a diagram illustrating an example of a performance monitoring kit (PMK) that may be used to calibrate a self-referencing spectral sensor according to some aspects. As shown in FIG. 29, in order to repeat some calibrations done by the factory, the customer may further be provided with performance management kit (PMK) 2900 that includes standard reference materials 2902/2904 for calibration. In addition to the PMK, a user-friendly software wizard may be provided with all the needed software algorithms to ensure an automated process. The standard materials 2902/2904 may be provided, for example, in material holders to be placed on top of an optical window 2908 of a self-referencing spectral sensor 2906. The PMK 2900 can be used to calibrate the internal reference with time against one or more of the standard materials 2902/2904 and to further monitor the performance of the light source. In some examples, the PMK may be used for calibration after replacement of the light source or optical head. In addition, the performance monitoring circuitry 354 may be configured to execute PMK software (e.g., using a PMK wizard) to call one or more PMK monitoring/correction routines.

In some examples, the spectral sensor manufacturer may recommend a periodicity of PMK calibration based on usage conditions of the spectral sensor (e.g., monthly). In other examples, the customer may be notified (e.g., by a signal) to perform PMK calibration based on a trigger (e.g., by a pre-set software timer, based on an alarm, as shown in FIG. 28, or in response to replacement of the optical head/light source). To utilize the PMK 2900, the customer can disassemble the spectral sensor 2906 from the line or otherwise enable access to the spectral sensor 2906 from the top of the spectral sensor 2906. The customer can then manually place a PMK material holder 2902 or 2904 containing a requested standard material on top of the optical window 2908 and call the PMK correction routine. In examples in which the trigger to utilize the PMK 2900 corresponds to replacement of the optical head/light source, the performance monitoring circuitry 354 can be notified of the replacement and call a PMK light source replacement and calibration routine.

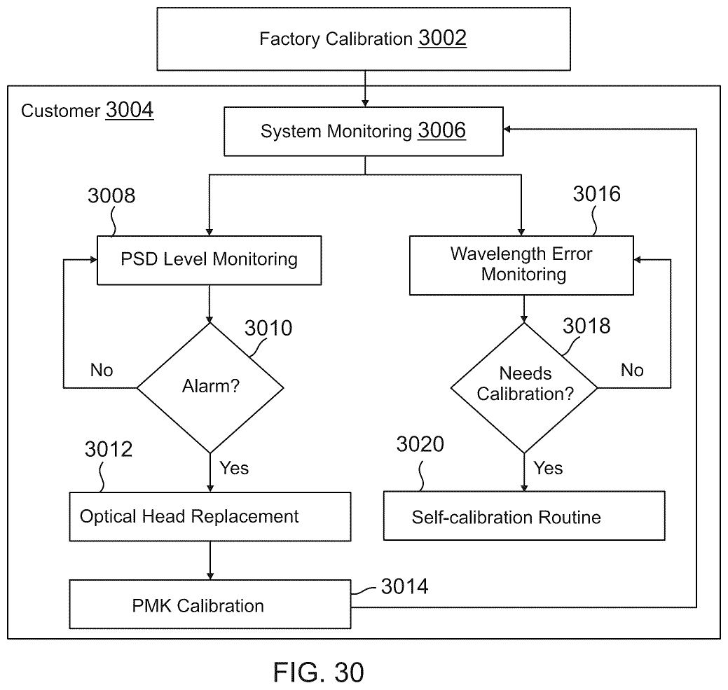

FIG. 30 is a diagram illustrating an example of spectral system monitoring process according to some aspects. After an initial calibration of the spectral sensor at the factory at block 3002, the spectral sensor is delivered to the customer and customer side system monitoring can begin at block 3004. System monitoring (e.g., as performed by the performance monitoring circuitry 354 shown in FIG. 3) is important to detect the need for self-calibration of the wavelength axis in addition to the y-axis (intensity) PSD degradation in a scheduled manner during system operation (e.g., during operation of the spectral sensor at the customer side).

For example, at block 3008, PSD level (intensity level) monitoring to monitor the power level of the light source may occur periodically (e.g., daily, weekly, monthly, etc.). If an alarm is issued at block 3010, indicating that the power level has dropped below a threshold, at block 3012, the optical head (or light source) may be replaced and at block 3014, a PMK calibration of the new optical head/light source may be performed. In addition, at block 3016, wavelength error monitoring may occur periodically (e.g., daily, weekly, monthly, etc.). If a wavelength error occurs at block 3018 that indicates that the spectral sensor should be calibrated (e.g., using the wavelength calibration mode or combined reference/wavelength calibration mode), then at block 3020, a wavelength self-calibration routine (e.g., using the wavelength calibration mode or combined reference/wavelength calibration mode) may be called. PMK of the self-calibration methods (such as the wavelength flag, LED lamp, etc.) can be performed as well upon necessity.

Table 1 below illustrates various exemplary system monitoring operations that may be performed on the spectral sensor.

TABLE 1

| | Additional | SW | | |
|---|---|---|---|---|
| Operation | HW | Routines | Intervention | Periodicity |
| Self- | No | Call the self- | No | Daily |
| referencing | | reference | | |
| and/or self- | | and/or self- | | |
| calibration | | calibration | | |
| | | routine | | |
| Performance | PMK | Call the | Yes | Month(s) |
| monitoring and | | PMK | | |
| adjustment | | routine | | |
| Light source | New light | Call the | Yes | Year(s) |
| replacement | source | calibration | | |
| | module | routine | | |
| | Calibration | | | |
| | kit (PMK) | | | |

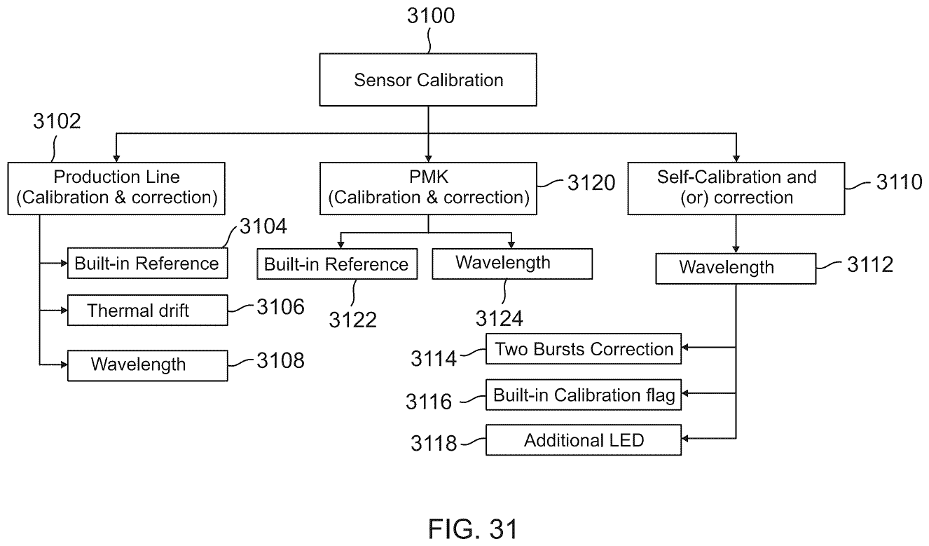

FIG. 31 is a diagram illustrating exemplary calibration and correction processes that can be applied to the spectral sensor according to some aspects. Sensor calibration processes 3100 may include, for example, various calibration and correction processes 3102 that can be performed during operation of the spectral sensor (e.g., on the production line of the sensor factory side). These production line calibration/correction processes 3102 can include, for example, built-in reference calibration/correction processes 3104, thermal drift calibration/correction processes 3106, and wavelength calibration/correction processes 3108. In addition, various self-calibration and/or correction processes 3110 may be performed during operation of the spectral sensor (on the customer side). For example, wavelength calibration/correction processes 3112 may include two burst wavelength correction processes 3114, built-in wavelength calibration processes 3116, or additional LED (calibration LED) processes 3118. Furthermore, various PMK calibration and correction processes 3120 may be performed at the customer side. For example, built-in reference PMK calibration/correction processes 3122 and PMK wavelength calibration/correction processes 3124 may be applied to the spectral sensor.

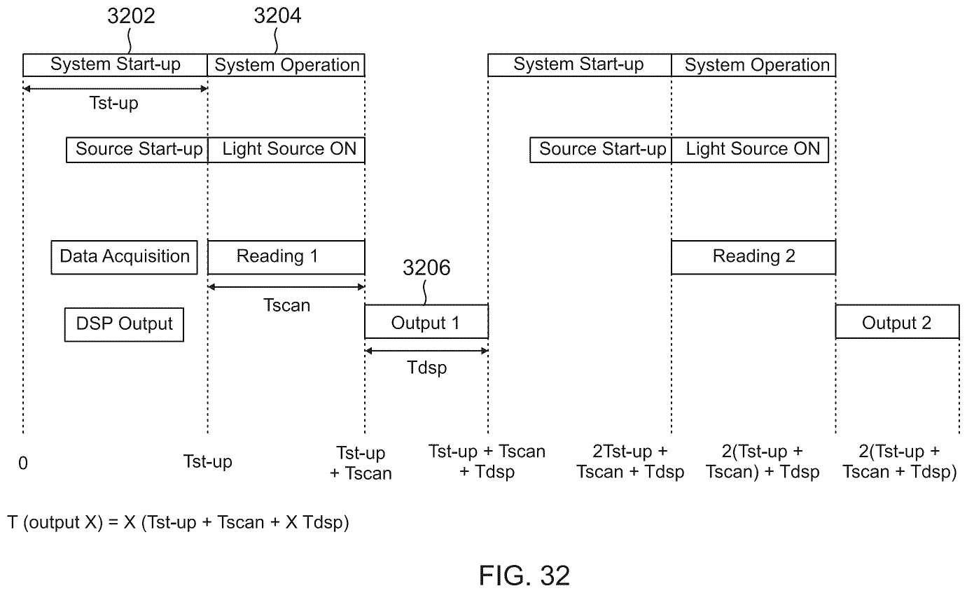

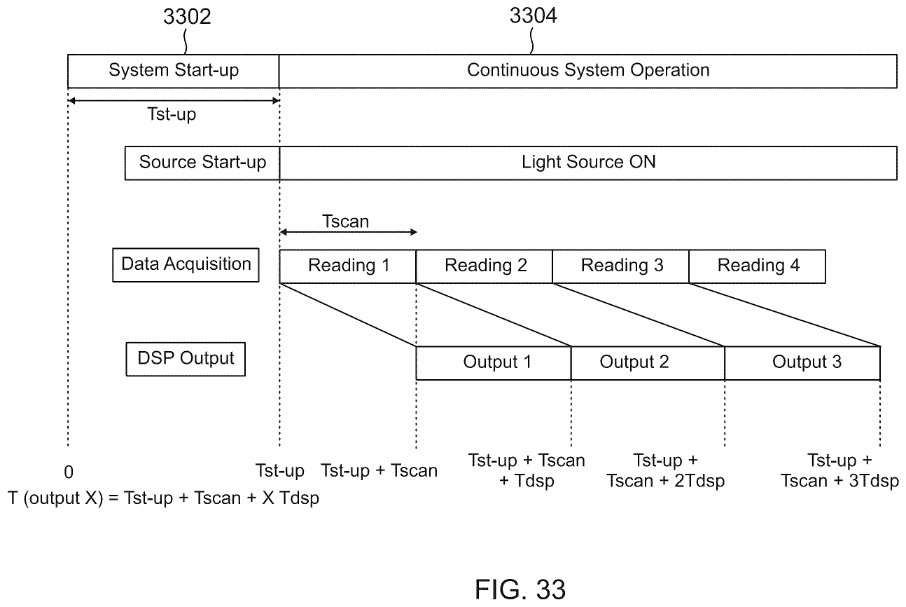

FIGS. 32 and 33 are diagrams illustrating examples of system operation of a spectral sensor according to some aspects. Spectrometer operation requires two stages; data acquisition from the optical spectral sensor and digital signal processing (DSP) done by the electronic chips. The timing diagram shown in FIG. 32 illustrates a normal system operation for multiple measurements. Before acquiring each reading, a start-up time (Tst-up) 3202 is needed to initiate the system and the light source. Then, the scans are obtained (Tscan) 3204m followed by the DSP stage (Tdsp) 3206. To increase the system throughput, parallelism of the two previous stages is proposed in a pipeline scheme, as shown in FIG. 33. The pipeline architecture has a single system start-up 3302 and then requires continuous light source and system operation 3304 without turning off between the scans to avoid the start-up delay. However, such mode of operation can reduce the lifetime of the light source lamps, thus optical head replacement may be necessary. For this purpose, monitoring the measurement of the internal background flag, as described above, can be useful to detect any reduction in the light source power. In addition, the continuous operation of the lamps may also increase the heating effect. This effect can be reduced by utilizing thermoelectric cooling (TEC) and/or applying temperature compensation matrices, generated from the calibration stage, with the help of the temperature sensors to correct for the thermal drift on both the x-axis and y-axis, as also described above.

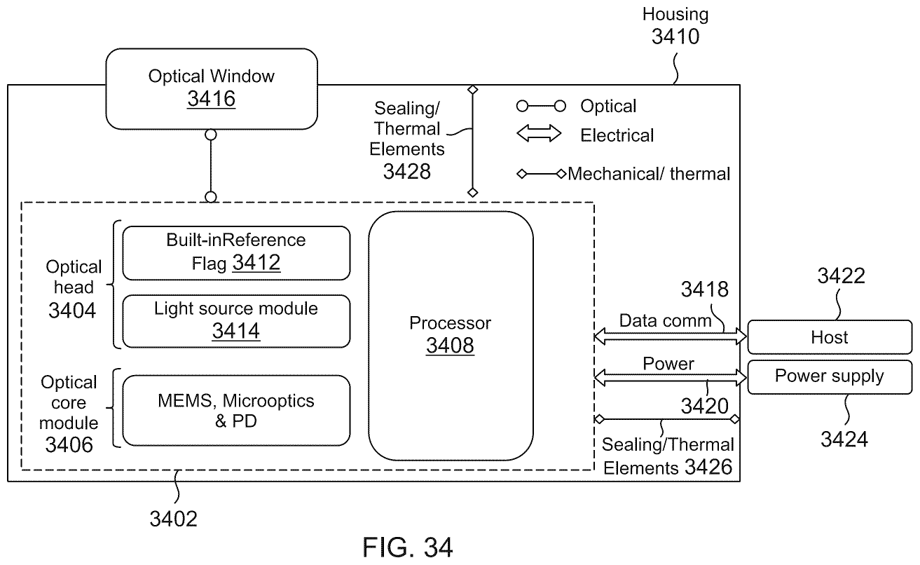

FIG. 34 is a diagram illustrating an example of an integrated spectral sensor according to some aspects. In the example shown in FIG. 34, the integrated spectral sensor 3400 includes an integrated sensor module 3402 that includes an optical head 3404, an optical core module 3406, and a processor 3408 integrated within a single housing 3410. The optical head 3404 includes a built-in moveable reference flag 3412 and a light source 3414 (e.g., which may include illumination and/or collection optics). The optical core module 3406 includes, for example, a light modulator (e.g., MEMS interferometer), detector, and optional micro optics. The spectral sensor 3400 further includes an optical window 3416 configured to provide input light from the light source 3414 to a sample (not shown) placed over the optical window 3416 and to direct diffuse reflected light from the sample back towards the optical core module 3406. The built-in moveable reference flag 3412 is configured, as described above, to be moveable between a first position beneath the optical window and within a light path of the input light and a second position away from the light path of the input light. In the first position, the reference flag 3412 is configured to diffusely reflect the input light towards the optical core module 3406 in the reference measurement mode to enable a reference PSD to be obtained by the processor 3408. In the second position, the light diffusely reflected from the sample is directed towards the optical core module 3406 to enable the processor 3408 to obtain a sample PSD. The processor 3408 is further configured to correct the sample PSD based on the reference PSD, as described above, to produce a sample spectrum.

The spectral sensor 3400 may further include data communication and power lines/traces 3418 and 3420 to facilitate communication between the spectral sensor 3400 and a host 3422 (e.g., a computing system external to the spectral sensor) and to allow for connection to an internal or external power supply 3424, such as a battery or other power source. The spectral sensor 3400 may further include sealing elements and/or thermal elements 3426 and 3428 to mechanically seal the spectral sensor and provide for thermal dissipation of various components of the spectral sensor 3400.

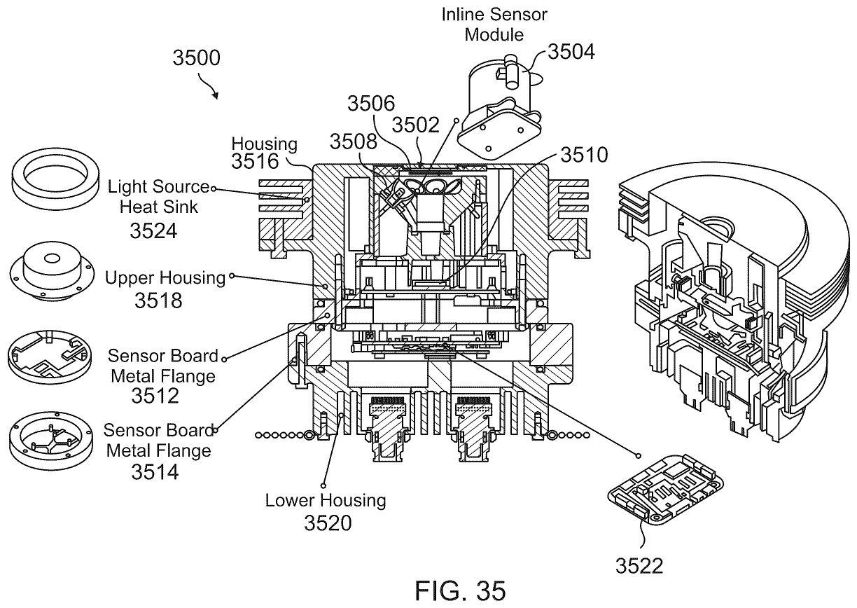

FIG. 35 is a diagram illustrating cross-sectional and expanded views of various components of an integrated spectral sensor according to some aspects. For example, FIG. 35 shows an architecture of online/inline integrated spectral sensor 3500 with a top-side optical window 3502, integrated sensor module 3504 with built-in reference flag (and solenoid) 3506 attached to a light source head 3508, and an optical core module 3510. The integrated spectral sensor 3500 may further include fixation flanges 3512 and 3514 configured to enable attaching the integrated sensor module 3504 and a processor/connector board 3522 to one another and to walls of a housing 3516 containing the integrated sensor module 3504. The housing 3516 may include an upper housing 3518 within which the integrated sensor module 3504 is housed and a lower housing 3520 within which the processor/connector board 3522 coupled to the integrated sensor module 3504 is housed. In addition, the integrated spectral sensor 3500 may include one or more heat sinks, including a light source heat sink 3524 to dissipate heat from the light source and other components of the integrated spectral sensor 3500.

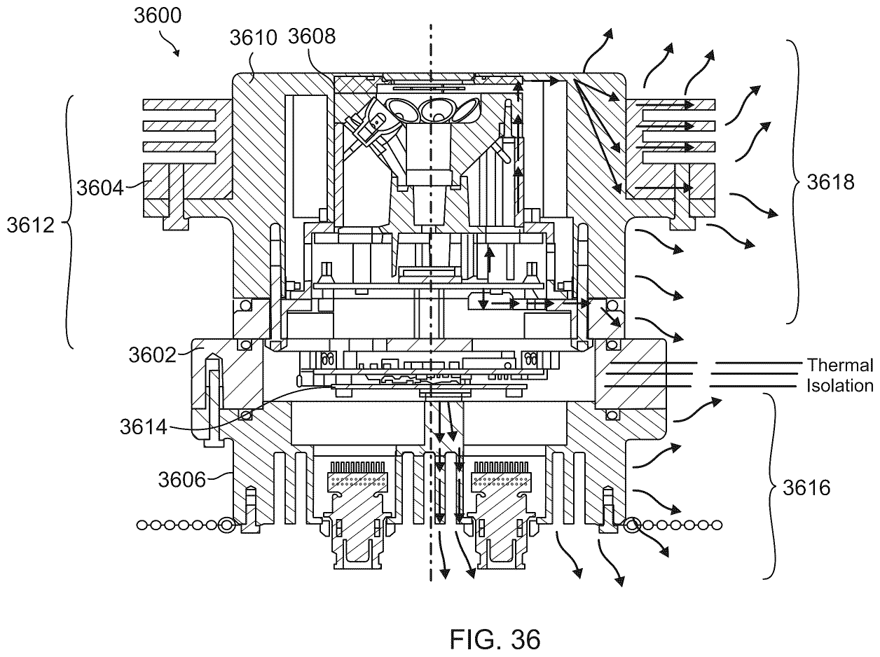

FIG. 36 is a diagram illustrating various thermal elements of a spectral sensor according to some aspects. In the example shown in FIG. 36, the spectral sensor 3600 includes one or more heat sinks 3602 and 3604 attached to the sides of the external housing at the fixation flanges to dissipate heat 3618 from an integrated spectral sensor 3612 (e.g., light source and detector), in addition to a backside heatsink 3606 to dissipate the heat 3616 generated from communication and processing boards 3614. The spectral sensor 3600 can further include additional thermal elements, such as thermal paste 3608 integrated into a housing 3610 of the spectral sensor. The different flanges (e.g., at 3602 and 3604) are used as well to attach the integrated sensor module 3612 to the communication and processing boards 3614, acting as thermal dissipation and isolation means.

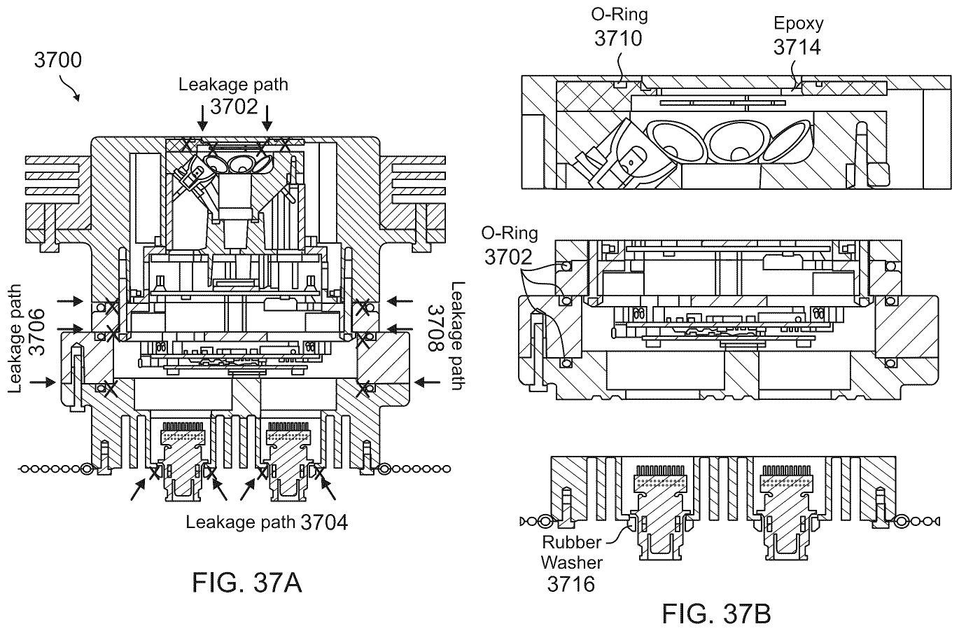

FIGS. 37A and 37B are diagrams illustrating various leakage paths and sealing mechanisms of a spectral sensor according to some aspects. For example, FIG. 37A illustrates several leakage paths 3702, 3704, 3706, and 3708 through the top, bottom, and sides of the spectral sensor 3700. In FIG. 37B, different sealing mechanisms are shown to reduce leakage of the spectral sensor. For example, O-rings 3710 and 3712 can be used for the different leakage paths near the optical window on the top of the spectral sensor and near the flanges on the sides of the spectral sensor. In addition, sealing epoxy 3714 can also be used on the optical window to seal the top of the spectral sensor. IP rated connectors with rubber washers 3716 can also be used on the bottom of the spectral sensor to ensure sealing at communication and powering ports.

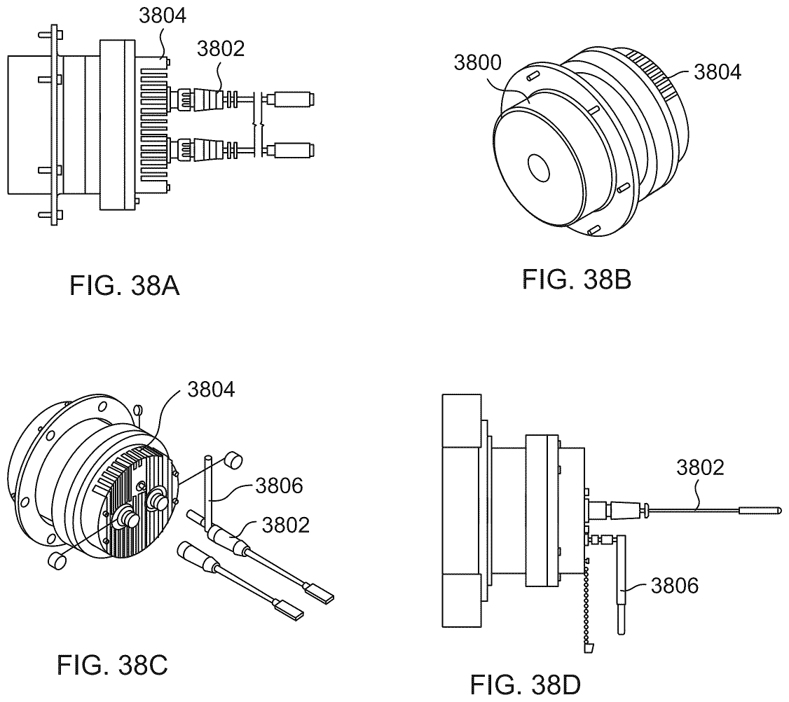

FIGS. 38A-38D are diagrams illustrating examples of external components that may be attached to a spectral sensor (modular with separate optical head/core sensor module or integrated), according to some aspects. For example, as shown in FIGS. 38A-38D, back-side communication and power ports 3802 may be connected to communication and powering boards (e.g., as shown in FIG. 35) of the spectral sensor 3800 through, for example, a back-side heat sink 3804. In addition, an antenna 3806 can be attached to the back-side of the spectral sensor 3800 to enable wireless communication between the spectral sensor 3800 and at least one wireless or network device.

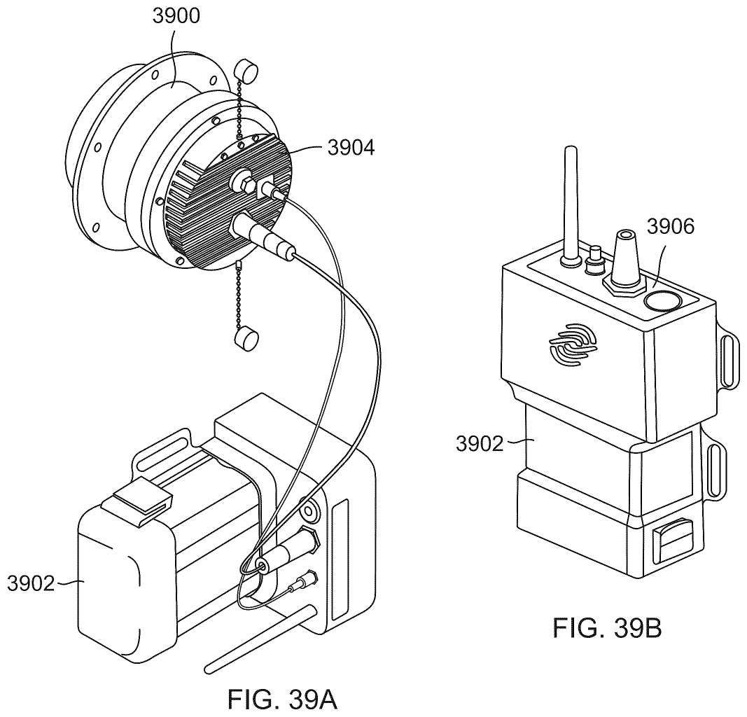

FIGS. 39A and 39B are diagrams illustrating configurations of a power source of a spectral sensor (modular or integrated) according to some aspects. In the example shown in FIG. 39A, the spectral sensor 3900 can be powered by an external battery module 3902 coupled (e.g., via power ports 3904 at the back-side of the spectral sensor. In the example shown in FIG. 39B, the external battery module 3902 can further include an antenna module 3906 for wireless communication.

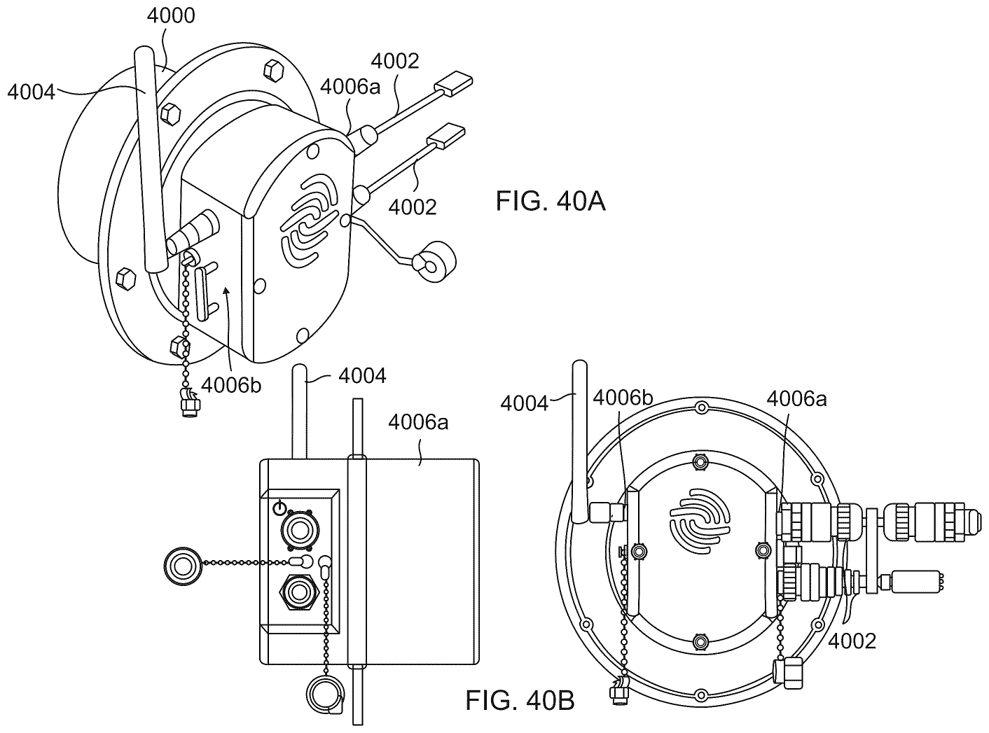

FIGS. 40A and 40B are diagrams illustrating other examples of external components that may be attached to a spectral sensor (modular or integrated), according to some aspects. For example, as shown in FIGS. 40A and 40B, communication and power ports 4002 may be connected to communication and powering boards (e.g., as shown in FIG. 35) of the spectral sensor 4000 through, for example, a side 4006a (e.g., lower part of the housing containing the core sensor module or the separate core sensor module) of a spectral sensor 4000. In addition, an antenna 4004 can be attached to an opposite side 4006b of the spectral sensor 4000 to enable wireless communication between the spectral sensor and at least one wireless or network device.

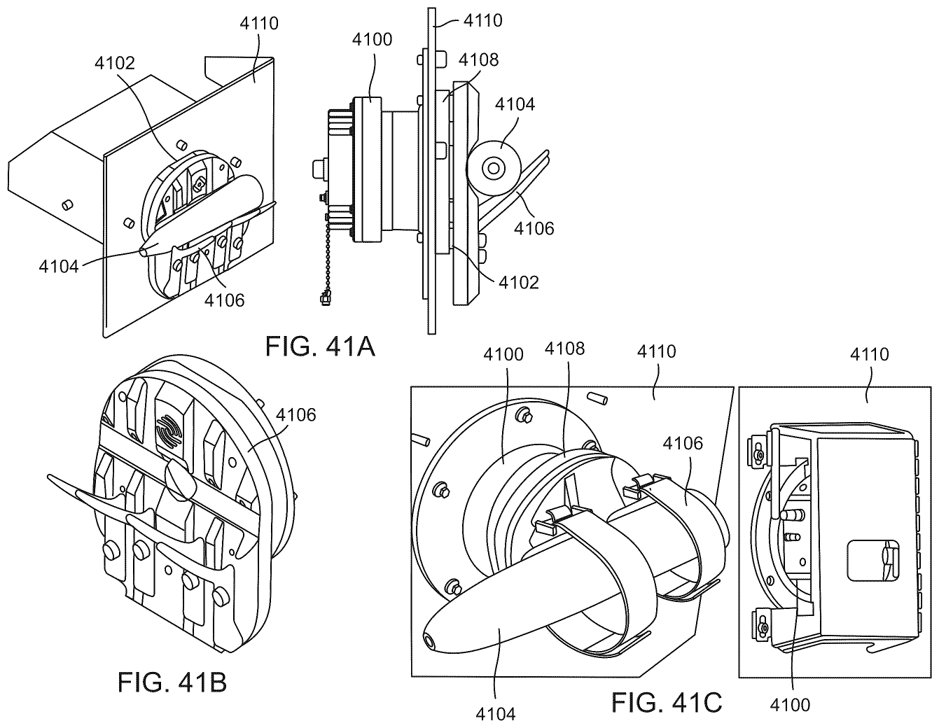

FIGS. 41A-41C are diagrams illustrating an example of an accessory that may be used with a spectral sensor (modular or integrated) according to some aspects. In the example shown in FIGS. 41A-41C, the spectral sensor 4100 can be used to measure certain characteristics or chemical contents/parameters of a corncob 4104 or any sample. For example, the spectral sensor 4100 may be attached to a wall 4110 from one side while the top-side optical window 4102 is protruding from the other side of the wall 4110. A corncob/sample 4104 may be attached to a sample holder 4106. The sample holder 4106 may be attached to a top side 4108 of the spectral sensor 4100. In some examples, as shown in FIGS. 41A and 41B, the sample holder 4106 can have four adjustable ears designed to hold the corncob in place in front of the optical window. In other examples, as shown in FIG. 41C, the sample holder 4106 can include two adjustable straps to fix the corncob well in front of the spectral sensor 4100.

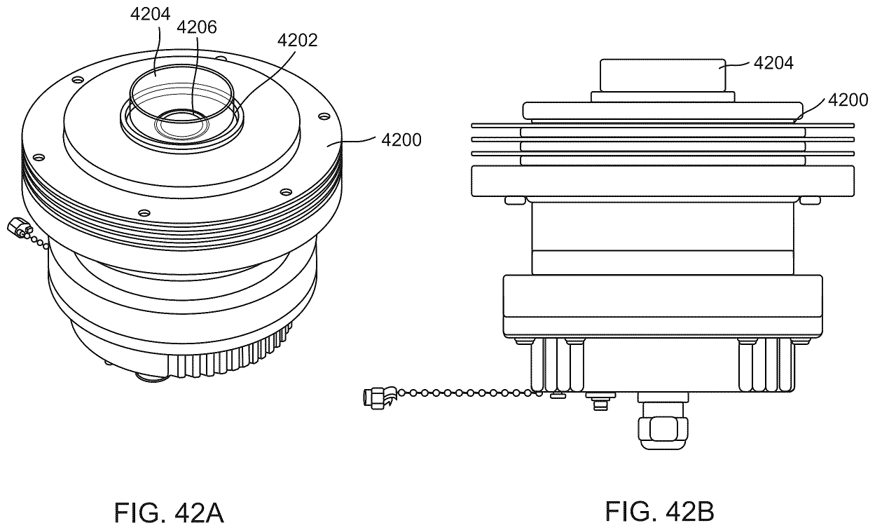

FIGS. 42A and 42B are diagrams illustrating other examples of accessories that may be used with a spectral sensor (modular or integrated) according to some aspects. In the example shown in FIGS. 42A and 42B, a holder (sample holder) accessory 4204 may be placed above an optical window 4202 of a spectral sensor 4200. In some examples, a petri-dish 4206 can be placed inside the sample holder 4204 with certain spacing to enable the spectral sensor 4200 to obtain a sample PSD of the sample on the petri-dish 4206.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-42B may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-42B may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A spectral sensor, comprising:
an optical head comprising:
a light source configured to produce input light,
an optical window directly above the light source and through which the input light is directed towards a sample and first diffuse reflected light is received from the sample in a sample measurement mode,
a moveable reference flag moveable between a first position beneath the optical window and within a light path of the input light in a reference measurement mode and a second position away from the light path of the input light in the sample measurement mode, wherein the moveable reference flag is coupled to receive the input light and diffuse reflect the input light to produce second diffuse reflected light in the reference measurement mode, and
an actuator configured to move the moveable reference flag between the first position and the second position; and
a core sensor module comprising:
an optical core module configured to receive the first diffuse reflected light from the sample in the sample measurement mode and the second diffuse reflected light from the moveable reference flag in the reference measurement mode, wherein the optical core module comprises:
a light modulator configured to produce first modulated light based on the first diffuse reflected light and second modulated light based on the second diffuse reflected light, and
a detector configured to produce a first output signal based on the first modulated light and a second output signal based on the second modulated light, and
a processor configured to obtain a sample power spectral density (PSD) based on the first output signal and a reference PSD based on the second output signal, wherein the processor is further configured to correct the sample PSD in both intensity and wavelength based on at least the reference PSD to produce a sample spectrum.

2. The spectral sensor of claim 1, wherein the optical head and the core sensor module are separate components configured to be removably attached to each other to facilitate replacement of at least one of the optical head or the core sensor module.

3. The spectral sensor of claim 2, wherein the optical head further comprises an electrical connector configured to connect to a mating element on the core sensor module for electrical connection therebetween, wherein the optical head further comprises a mechanical connector configured to provide a mechanical connection to the core sensor module.

4. The spectral sensor of claim 3, wherein the optical head and the core sensor module each comprise respective alignment pins configured to facilitate attachment of the optical head to the core sensor module via the electrical connector, the mating element, and the mechanical connector.

5. The spectral sensor of claim 2, wherein the optical head comprises a first aperture configured to be aligned with a second aperture on the core sensor module to provide the first diffused reflected light and the second diffuse reflected light from the optical head to the core sensor module.

6. The spectral sensor of claim 1, wherein the actuator comprises a solenoid configured to move the moveable reference flag between the first position and the second position, wherein the solenoid is attached to a bracket holder that is part of a mechanical chassis of the optical head or integrated with a reflector holder of the optical head, wherein the reflector holder is configured to hold a plurality of reflectors that are configured to reflect the input light towards the optical window.

7. The spectral sensor of claim 6, wherein the optical head further comprises:
an additional solenoid configured to control a vertical distance between the moveable reference flag and a fixed reference plate; and
a capacitive sensing circuit configured to sense a sensed capacitance between the fixed reference plate and the moveable reference flag based on the vertical distance, to convert the sensed capacitance into a current, and to provide the current to the additional solenoid to adjust the vertical distance.

8. The spectral sensor of claim 6, wherein the optical head further comprises:
an additional solenoid configured to control a vertical distance between the moveable reference flag and a fixed reference plate; and
a capacitive sensing circuit configured to sense a sensed capacitance between the fixed reference plate and the moveable reference flag based on the vertical distance, wherein the processor is configured to correct the reference PSD based on the sensed capacitance.

9. The spectral sensor of claim 6, wherein the optical head further comprises:
an optical proximity sensor positioned on an arm of the moveable reference flag and configured to measure a vertical distance between the moveable reference flag and a reference surface and to provide the vertical distance to the processor, wherein the processor is configured generate a correction matrix based on the vertical distance and to apply the correction matrix to the reference PSD to produce a corrected reference PSD that is used to correct the sample PSD.

10. The spectral sensor of claim 1, wherein the processor is further configured to divide the sample PSD by the reference PSD to produce the sample spectrum.

11. The spectral sensor of claim 1, wherein the processor is further configured to compensate for a spectral response difference between the reference PSD and the sample PSD based on a compensation function indicative of an optical power difference between the first position of the moveable reference flag below the optical window and a sample position of the sample above the optical window.

12. The spectral sensor of claim 11, wherein the compensation function is further indicative of at least one of one or more spectral variations produced by the optical window or an accessory configured to hold the sample above the optical window or one or more variations in the moveable reference flag.

13. The spectral sensor of claim 1, wherein the processor is further configured to calculate a power thermal drift of the reference PSD based on a correction matrix across a wavenumber vector of the reference PSD that is associated with a current temperature of the spectral sensor, wherein the processor is further configured to correct the sample PSD based on the power thermal drift to produce the sample spectrum.

14. The spectral sensor of claim 13, further comprising:
a memory configured to store the correction matrix, a previous temperature and a previous reference PSD obtained at the previous temperature, wherein the processor is configured to obtain the reference PSD and store the reference PSD and the current temperature associated therewith in response to a difference between the current temperature and the previous temperature being greater than a threshold.

15. The spectral sensor of claim 14, further comprising:
a thermo-electric cooling (TEC) system configured to stabilize the current temperature around the previous temperature, wherein the TEC system is configured to apply temperature stabilization in response to the difference between the current temperature and the previous temperature being less than the threshold.

16. The spectral sensor of claim 15, wherein the TEC system is configured to apply temperature stabilization prior to application of the correction matrix by the processor based on an allowed temperature difference between the sample PSD and the reference PSD being greater than an allowed temperature threshold margin.

17. The spectral sensor of claim 13, wherein the cores sensor module further comprises:
a sensor board comprising the optical core module, wherein the sensor board comprises copper configured to dissipate heat from a thermal aggressor on the sensor board away from the optical core module or minimize an amount of the copper shared between the optical core module and the thermal aggressor.

18. The spectral sensor of claim 13, wherein the processor is further configured to multiply the wavenumber vector by at least one wavenumber correction factor based on the current temperature to calculate a wavelength thermal drift of the reference PSD, wherein the processor is further configured to correct the sample PSD based on the wavelength thermal drift to produce the sample spectrum.

19. The spectral sensor of claim 13, further comprising:
at least one temperature sensor configured to obtain the current temperature.

20. The spectral sensor of claim 19, wherein the at least one temperature sensor comprises a first temperature sensor adjacent the detector and a second temperature sensor adjacent the light modulator.

21. The spectral sensor of claim 13, further comprising:
a memory configured to store a table comprising a relation between a plurality of temperatures and a plurality of corresponding wavelength detector cut-off points, wherein the processor is configured to identify a current wavelength detector cut-off point of the reference PSD and to extract the current temperature corresponding to the current wavelength detector cut-off point from the table.

22. The spectral sensor of claim 1, wherein the moveable reference flag configured to produce an intensity measurement associated with the reference PSD in the reference measurement mode, and further comprising:
a moveable wavelength calibration flag moveable between a respective additional first position configured to produce a wavelength measurement in a wavelength calibration mode and a respective additional second position in the sample measurement mode, wherein the processor is configured to correct the sample PSD based on the intensity measurement and the wavelength measurement.

23. The spectral sensor of claim 22, wherein the optical head comprises the moveable reference flag configured to produce the intensity measurement in the reference measurement mode at a first time, and wherein the optical head further comprises the moveable wavelength calibration flag configured to produce the wavelength measurement in the wavelength calibration mode at a second time, wherein the processor is configured to correct the sample PSD and the reference PSD based on the wavelength measurement and to correct the sample PSD based on the intensity measurement to produce the sample spectrum.

24. The spectral sensor of claim 23, further comprising:
a memory configured to store a plurality of standard wavelength peaks, wherein the processor is configured to obtain a plurality of reference wavelength peaks based on the wavelength measurement and to calculate a plurality of wavenumber correction factors based on the plurality of standard wavelength peaks and the plurality of reference wavelength peaks, wherein the processor is configured to correct the reference PSD and the sample PSD based on the plurality of wavenumber correction factors to produce the sample spectrum.

25. The spectral sensor of claim 23, wherein the actuator comprises a stepper motor configured to control each of the moveable reference flag and the moveable wavelength calibration flag.

26. The spectral sensor of claim 23, wherein the actuator comprises a first solenoid configured to control the moveable reference flag and a second solenoid configured to control the moveable wavelength calibration flag.

27. The spectral sensor of claim 22, wherein the core sensor module comprises the moveable wavelength calibration flag, wherein the moveable wavelength calibration flag is moveable between the respective additional first position above the light modulator and within an additional light path of the second diffuse reflected light in a combined reference/wavelength calibration mode and the respective additional second position away from the additional light path of the second diffuse reflected light in the sample measurement mode, wherein the moveable wavelength calibration flag is coupled to receive the second diffuse reflected light and transmit the second diffuse reflected light towards the light modulator as filtered diffuse reflected light in the combined reference/wavelength calibration mode, and further comprising:
an additional actuator within the core sensor module and configured to move the moveable wavelength calibration flag between the respective additional first position and the respective additional second position.

28. The spectral sensor of claim 27, wherein the moveable reference flag and the moveable wavelength calibration flag are moved into the respective first position and the respective additional first position simultaneously.

29. The spectral sensor of claim 27, wherein the processor is configured to divide the sample PSD taken in the sample measurement mode by the reference PSD taken in the combined reference/wavelength calibration mode after applying wavelength correction for both the reference PSD and the sample PSD based on the wavelength measurement to produce the sample spectrum.

30. The spectral sensor of claim 1, wherein the light source comprises a reference light emitting diode (LED) having a specific wavelength in an operating spectral range of the spectral sensor, wherein the reference LED is turned on during a combined reference/wavelength calibration mode and any other light-emitting sources of the light source are turned off during the combined reference/wavelength calibration mode to obtain a wavelength measurement together with the reference PSD, wherein the processor is configured to apply wavelength correction to the sample PSD and the reference PSD based on a reference peak location of the reference LED in the wavelength measurement.

31. The spectral sensor of claim 1, wherein the light modulator comprises a micro-electrical mechanical systems (MEMS) interferometer comprising a fixed mirror and a moveable mirror, and further comprising:
a self-calibration circuit in the optical core module configured to recalibrate a capacitance to mirror displacement (C2X) relation of the moveable mirror based on the reference PSD, wherein the processor is configured to apply wavelength correction to the sample PSD and the reference PSD based on the C2X relation.

32. The spectral sensor of claim 1, further comprising:
an inertial sensor configured to sense an inertial force on the spectral sensor.

33. The spectral sensor of claim 32, wherein the processor is further configured to correct the sample PSD based on the inertial force to produce the sample spectrum.

34. The spectral sensor of claim 32, further comprising:
a platform on which the spectral sensor is located; and
a platform actuator configured to adjust an angle of the platform with respect to a horizontal axis based on the inertial force.

35. The spectral sensor of claim 1, wherein the light source comprises a plurality of filament lamps, and further comprising:
a circular board on which the plurality of filament lamps are soldered; and
a plurality of reflectors surrounding the plurality of filament lamps on the circular board, wherein the circular board is configured to be inserted into and removed from the optical head.

36. The spectral sensor of claim 1, wherein the processor is further configured to provide a signal requesting replacement of the optical head in response to detecting a power reduction above a threshold based on the reference PSD.

37. The spectral sensor of claim 1, wherein the processor is further configured to provide a signal requesting wavelength calibration of the spectral sensor in response to replacement of the optical head or at least one parameter associated with a wavelength measurement exceeding a threshold, or based on a periodicity of calibration.

38. The spectral sensor of claim 37, wherein the signal indicates calibration to be performed based on a performance monitoring kit that comprises at least one standard material placed on top of the optical window.

39. The spectral sensor of claim 1, wherein the processor is configured to turn on the light source and initiate a first scan of the sample at a first time and to process the first output signal corresponding to the first scan to obtain the sample spectrum at a second time subsequent to the first time, wherein the processor is further configured to maintain the light source in an on state at the second time to initiate a second scan of the sample at the second time in a pipeline configuration between sample scans and processing respective output signals of the sample scans.

40. The spectral sensor of claim 1, wherein the optical head and the core sensor module are integrated into a single housing, wherein the housing comprises the optical window on a top surface thereof and at least one fixation flange configured to attach the spectral sensor to one or more walls of the housing.

41. The spectral sensor of claim 40, wherein the housing comprises at least one heatsink attached to the one or more walls of the housing at the at least one fixation flange and an additional backside heatsink near a bottom surface of the housing.

42. The spectral sensor of claim 1, further comprising:
one or more of a battery module to power the spectral sensor or an antenna module configured to enable communication between the spectral sensor and at least one external device.
